(19) United States
(12) Patent Application Publication
(10) Pub. No.: US 2024/0067524 A1
(43) Pub. Date: Feb. 29, 2024

(54) METHOD OF PREPARING AN ELECTROCATALYST

(71) Applicant: THE HONG KONG POLYTECHNIC UNIVERSITY, Hong Kong (CN)

(72) Inventors: Lawrence Yoon Suk LEE, Hong Kong (CN); Mengjie LIU, Hong Kong (CN)

(21) Appl. No.: 18/455,677

(22) Filed: Aug. 25, 2023

Related U.S. Application Data
(60) Provisional application No. 63/401,364, filed on Aug. 26, 2022.

(51) Int. Cl. C01B 25/37; H01M 10/0525

(52) U.S. Cl. CPC C01B 25/375; H01M 10/0525; C01P 2002/52; C01P 2004/84; C01P 2006/12; C01P 2006/40

(57) ABSTRACT

Sustainable upcycling method of preparing an electrocatalyst, the method including: providing an electrode material obtained from a lithium-ion battery, wherein the electrode material includes LiFePO₄@N-doped carbon core-shell particles; contacting the electrode material with an aqueous solution comprising an acid thereby forming the electrocatalyst; and optionally drying the electrocatalyst.

### CROSS-REFERENCE TO RELATED APPLICATIONS

The present application claims priority from U.S. Provisional Patent Application No. 63/401,364, filed on Aug. 26, 2022, which is hereby incorporated by reference in its entirety.

### TECHNICAL FIELD

The present disclosure relates to methods for preparing electrocatalysts from electrode material obtained from, e.g., depleted lithium-ion batteries.

### BACKGROUND

The shift in the energy paradigm from fossil fuels to renewable energies has set a pressing demand for reliable and scalable technologies for energy harvest, conversion, and storage.¹ Lithium-ion battery (LIB) is widely regarded as a successful energy storage system that can complement renewable energy resources of the intermittent nature. Thus, LIB has gained a leading position in the battery market over the past two decades, making portable electronics ubiquitous in our daily life. With the growing demands for electric vehicles and stationary energy storage grids, an exponential increase in the production and consumption of LIBs, as well as an ever-increasing quantity of spent LIBs is foreseeable, which would bring serious challenges for waste management and environment protection. Currently, there is no clear path to the economic and sustainable recycling of end-of-life LIBs, and only about 5% of spent LIBs are collected and recycled worldwide. These spent LIBs are mostly recycled by high-temperature melting and extraction or smelting processes that are energy-intensive yet inefficient. The end-of-life LIBs are concentrated resources of some 3d transition metals (e.g., Co, Ni, Fe, and Mn) and Li and can be considered as an urban mine with huge economic advantages over traditional mining. There is thus an urgent need to establish an efficient LIB recovery process for economic and environmental reasons.

In the 3R (reduce, recycle, and reuse) strategy, the recycle and reuse generally refer to the development of a closed-loop system where the key components are recycled as pure chemicals for production or are reused in LIBs and other applications. The reuse of LIBs may avoid complicated steps such as pyrometallurgical and hydrometallurgical steps, and is located at a higher position in the waste management hierarchy. The advantage in energy efficiency and technical viability of reusing spent LIB electrodes have been demonstrated, but less attention has been paid to the upcycling of LIB materials across the application fields.

In addition to LIBs, fuel cells (FCs) and Zn-air batteries (ZABs) are two other electrochemical energy conversion devices that have shown compelling potential in powering electronic devices. Although the electrochemical reactions occurring in these devices differ from those in LIBs, they share common features in the design principle of electrode materials. The microstructure, surface/interface properties, and electronic/atomic configuration of electrodes are all critical factors that determine the performance and lifetime of the devices. Recent studies on the role of electrocatalysts in Li—S and Li—O₂ batteries also suggest an inherently close link between energy conversion and storage applications. Given that sustainability can be counted as an extra dimension of an electrode in addition to structure and property, the fabrication of the electrodes for FC and/or ZAB using the materials from spent LIBs via simple modifications would represent a paradigm-shifting concept of upcycling that improves the energy efficiencies in terms of both waste recycling and new device production. The energy conversion efficiencies of FC and ZAB are primarily limited by the high overpotential of oxygen reduction reaction (ORR) that involves multiple electron transfers to diverse intermediates. The development of cost-effective ORR electrocatalysts, as an alternative to the noble-metal-based ones, is the key to the large-scale commercialization of FC and ZAB. Transition-metal single atoms (SAs) embedded in a carbon matrix have demonstrated excellent ORR performances owing to their unique merits of high catalytic activity and maximum atomic utilization. The rational design of such SA-based catalysts (SACs) has been usually accomplished by bottom-up approaches using organometallic precursors. The electronic configuration of active SA sites could be further modulated by incorporating another SA of different metal or sub-nanoscale metal cluster in their vicinity, but the construction of such dual-atomic or SA—cluster catalysts with good uniformity and high loading remains very challenging. Due to this difficulty in atomic control, the top-down strategy has rarely been considered for the construction of SACs. However, the cathode materials in spent LIBs could offer an opportunity to construct SACs via the top-down approach. The digested cathodes (e.g., LiCoO₂, LiMn₂O₄, and LiFePO₄) can provide metal atoms for creating SA/cluster sites while additives such as super P and/or carbon coatings of the cathode can serve as conductive supports that anchor the metal species via the coordination with electron-donating heteroatoms or defect sites.

### SUMMARY

Provided herein is a method of reforming cathode materials in spent LIB into an active SA-based ORR catalyst. A previously reported LIB cathode, the LiFePO₄ (LFP) encapsulated with N-doped carbon spheres, was selected as a proof-of-concept model system. The end-of-life LFP electrode was partially etched to produce an ensemble of Fe SAs (SA_{Fe}), nanoscale FeO clusters, and residual LFP nanoparticles that were embedded in the hollow carbon sphere. Our characterizations indicate that the unsaturated O-coordinated SAF, sites are highly active in catalyzing ORR under alkaline conditions, which is assisted by the synergistic effect of the nearby FeO cluster and LFP particle. The hollow carbon contributes to the catalysis by serving as the matrix that stabilizes metal species and facilitates electron transfer and electrolyte penetration. When employed as the membrane electrodes in ammonia FC and ZAB, the SA_{Fe}/FeO/LFP catalyst shows superior peak power density and durability, demonstrating a new concept of cross-device upcycling.

Provided herein is a method of preparing an electrocatalyst, the method comprising: providing an electrode material obtained from a lithium-ion battery, wherein the electrode material comprises LiFePO₄@N-doped carbon core-shell particles; contacting the electrode material with an aqueous solution comprising an acid thereby forming the electrocatalyst; and optionally drying the electrocatalyst.

In certain embodiments, the aqueous solution has a pH less than 3.

In certain embodiments, the aqueous solution has a pH between −1 to 1.

In certain embodiments, the acid selected from the group consisting of HCl, HBr, HI, H₂SO₄, MHSO₄, or a mixture thereof, wherein M is an alkali metal or an alkaline earth metal.

In certain embodiments, the aqueous solution comprises HCl at a concentration of 1.5 to 2.5 M.

In certain embodiments, the electrode material and the aqueous solution remain in contact for 5-240 minutes.

In certain embodiments, the aqueous solution comprises HCl at a concentration of 1.75 to 2.25 M and the electrode material and the aqueous solution remain in contact for 5-15 minutes.

In certain embodiments, the aqueous solution comprises HCl at a concentration of 1.8-2.2 M and the electrode material and the aqueous solution remain in contact for 10-240 minutes.

In certain embodiments, the aqueous solution comprises HCl at a concentration of 1.8-2.2 M and the electrode material and the aqueous solution remain in contact for 5-15 minutes.

In certain embodiments, the electrode material and the aqueous solution are contacted at a ratio of 0.1-1 mg of electrode material to 1 mL of aqueous solution.

The method of claim 1, wherein the electrocatalyst has a Brunauer-Emmett-Teller (BET) surface area between 500-800 m² g⁻¹.

In certain embodiments, the electrocatalyst comprises iron at a concentration of 2.63-3.71 wt. %.

In certain embodiments, the method further comprises providing a crude electrode material comprising the LiFePO₄@N-doped carbon core-shell particles, a binder, and one or more volatile organic solvents, wherein the crude electrode material is obtained from the lithium-ion battery; extracting the crude electrode material with an organic solvent thereby removing at least a portion of the binder from the crude electrode material; and drying the crude electrode material thereby removing at least a portion of the one or more volatile organic solvents from the crude electrode material and forming the electrode material.

In certain embodiments, the electrocatalyst is dried by freeze-drying.

In certain embodiments, the method further comprises combining the electrocatalyst with an electrolyte.

In certain embodiments, the electrolyte comprises a sulfonated tetrafluorethylene and perfluorovinylether copolymer.

The method of claim 1 further comprising affixing the electrocatalyst to a negative current collector.

In certain embodiments, the aqueous solution comprises HCl at a concentration of 1.8-2.2 M and the electrode material and the aqueous solution remain in contact for 5-15 minutes; the electrode material and the aqueous solution are contacted at a ratio of 0.05-.15 mg of electrode material to 1 mL of aqueous solution; and the electrocatalyst has a Brunauer-Emmett-Teller (BET) surface area between 515.9-742.3 m² g⁻¹.

In certain embodiments, the electrocatalyst comprises iron at a concentration of 2.63-3.71 wt. %.

In certain embodiments, the method further comprises depositing the electrocatalyst on a negative current collector.

In a second aspect, provided herein is an electrocatalyst prepared in accordance with the method described herein.

In a third aspect, provided herein is an electrochemical cell comprising: an electrode comprising the electrocatalyst described herein; a counter electrode; optionally a reference electrode; and an electrolyte.

### BRIEF DESCRIPTION OF THE DRAWINGS

FIG. 1 depicts (A) upcycling process of spent LIBs: mechanical dismantling, physical separation, post-thermal treatment, and partial etching. Digital photographs show a disassembled 18650 LiFePO₄ cell. (B) Schematic illustration and (C) the corresponding TEM images showing the partial etching process of the spent LiFePO₄/N-doped carbon (LFP/C) cathode to a-LFP/C, LFP/C-1, LFP/C-2, and LFP/C-3.

FIG. 2 depicts (A) powder XRD patterns of LFP/C, a-LFP/C, LFP/C-1, LFP/C-2, and LFP/C-3. (B) TEM image of LFP/C-1. (C) A magnified TEM image showing the lattice planes of the etched LFP particle in LFP/C-1, (D) the corresponding FFT pattern, (E) HAADF-STEM and the corresponding EDX elemental mapping images, and (F) aberration-corrected HAADF-STEM image. (G) Typical EELS line scan across the hollow carbon sphere of LFP/C-1 and the corresponding HAADF image.

FIG. 3 depicts (A) high-resolution O 1s XPS spectrum of LFP/C-1. (B) Normalized Fe K-edge XANES spectra and (C) Fourier transform (FT) profiles of Fe K-edge k²-weighted EXAFS data of LFP/C, LFP/C-1, LFP/C-2, and reference samples of FeO and Fe₂O₃. (D) Calculated Fe—X (X═O, P, Fe) distances in LiFePO₄ olivine structure. (E) WT contour plots for EXAFS signals of LFP/C, LFP/C-1, and LFP/C-2. White dotted lines indicate the k-value shifting of Fe—P(Fe) scatterings at the high k range.

FIG. 4 depicts (A) ORR polarization curves at 1,600 rpm in O₂-saturated 1 M KOH. (B) Electron transfer number (n) and HO₂⁻ yield plotted against applied potential. (C) Chronoamperometric responses of LFP/C-1 and Pt/C in stability test. Insets are the polarization curves before and after cycles and the methanol tolerance test recorded at 0.3 V. (D) SCN⁻ poisoning experiments represented by LSV curves in 0.5 M H₂SO₄. Insets in (d) are the illustration of SCN⁻ blocking effect on SA_{Fe} in the samples.

FIG. 5 depicts (A) top-views and side-views of modeling structures of FeO₄, FeO₄/(FeO₆)₂, and FeO₄/(FeO₆)₂/LFP on graphene slabs. (B) Projected density of states for the corresponding models. (C) Schematic diagram of orbital hybridization of the adsorbates bonding orbitals and 3d orbitals of Fe. (D) The corresponding free energy diagrams for ORR at U=1.23 V, pH=0. (E) Linear relationships of the theoretical overpotential (i/theo) and d-band center energy value (E_{d}) with the Gibbs free energy of OH* (ΔG_{OH*}).

FIG. 6 depicts illustrations of the setups for (A) ammonia fuel cell (FC) and (B) Zn—air battery (ZAB). (C) Discharge polarization curves of FCs constructed with LFP/C-1, LFP/C-2, and Pd/C and the corresponding power density plots. (D) Discharge polarization curves and the corresponding power density plots of rechargeable ZABs constructed with LFP/C-1 and Pt/C+RuO₂. (E) Radar chart summarizing ORR activity, selectivity, stability, and the corresponding power densities of the FC and ZAB.

FIG. 7 depicts a flow chart representing the typical routes of recycling LIBs with the details of mechanical dismantling, physical separation, and materials recovery steps.

FIG. 8 depicts scanning electron microscopy (SEM)images of (A) pristine LFP/C, (B) a-LFP/C, (C) LFP/C-1, (D) LFP/C-2, and (E) LFP/C-3.

FIG. 9 depicts (A) transmission electron microscopy (TEM) and (B) high-resolution transmission electron microscopy (HRTEM) images of pristine LFP/C. Inset in (B) is the FFT pattern. (C) Elemental mapping images of C, N, Fe, P and O elements.

FIG. 10 depicts (A) TEM and (B) HRTEM images of a-LFP/C. Inset in (B) is the FFT diffraction pattern.

FIG. 11 depicts LFP/C-1. (A) TEM image showing the partially etched LiFePO₄ particle. (B) HRTEM image showing the hollow carbon sphere. (C, D) Elemental mapping images of C, N, Fe, P, and O in two selected areas of LFP/C-1.

FIG. 12 depicts LFP/C-2. (A) TEM and (B) HRTEM images. (C) Elemental mapping images of C, N, Fe, P, and P elements.

FIG. 13 depicts LFP/C-3. (A) TEM and (B) HRTEM images.

FIG. 14 depicts a schematic diagram of LiFePO₄ olivine structure.

FIG. 15 depicts an aberration-corrected HAADF-STEM images of (A, B) LFP/C-1 and (C, D) LFP/C-2. Circles indicate FeO clusters.

FIG. 16 depicts (A) N₂ adsorption—desorption isotherms and (B) the corresponding pore distribution plots of LFP/C, LFP/C-1, LFP/C-2, and LFP/C-3. Inset in (a) compares the surface areas of the samples.

FIG. 17 depicts a table showing Fe and Li contents in the pristine and etched LFP/C samples determined by inductively coupled plasma optical emission spectrometry (ICP-OES).

FIG. 18 depicts a table showing element contents determined by elemental analysis.

FIG. 19 depicts (A) XPS survey spectrum, (B) Fe 2p, (C) Li 1s, (D) P 2p, (E) N 1s, and (F) C is spectra of LFP/C-1.

FIG. 20 depicts a table showing surface element contents in LFP/C-1 determined by XP S.

FIG. 21 depicts Fe K-edge EXAFS fitting curves of (A, B) LFP/C, (C, D) LFP/C-1, and (E, F) LFP/C-2 in R and K spaces, respectively. K-ranges were selected as 3.347-12.536, 3.694-12.334, and 3.750-10.984 Å⁻¹ for LFP/C, LFP/C-1, and LFP/C-2, respectively.

FIG. 22 depicts a table showing fitting results of Fe K-edge FT-EXAFS data.

FIG. 23 depicts (A) ORR cyclic voltammograms in Ar- (dash) and O₂-saturated (solid) 1 M KOH, (B) ORR onset potentials (Eₒₙₛₑₜ) and (C) half-wave potentials (E_{1/2}) obtained from the polarization curves, and (C) the corresponding Tafel plots of LFP/C samples and Pt/C.

FIG. 24 depicts ORR polarization curves of (A) Pt/C, (B) LFP/C, (C) LFP/C-1, (D) LFP/C-2, and (E) LFP/C-3 at various rotating speeds in O₂-saturated 1 M KOH. (F) Kouteck-Levich (K-L) plots derived from the polarization curves of various rotating speeds at 0.6 V vs. RHE.

FIG. 25 depicts RRDE curves of as-prepared LFP/C catalysts and Pt/C at 1,600 rpm (top: ring currents; bottom: disk currents).

FIG. 26 depicts (A) XPS survey spectrum, (B) Fe 2p, (C) Li 1s, (D) N 1s, (E) O 1s, (F) P 2p, and (G) C is spectra of LFP/C-1 after 500 cycles of ORR test.

FIG. 27 depicts TEM image of LFP/C-1 after 500 cycles of ORR test.

FIG. 28 depicts an illustration of ORR mechanism at FeO₄/(FeO₆)₂/LFP model. Other two models of FeO₄ and FeO₄/(FeO₆)₂ show the same active site and pathway.

FIG. 29 depicts ORR free energy diagrams of FeO₄/(FeO₆)₂ and FeO₄/(FeO₆)₂/LFP at U=0 V, pH=0.

FIG. 30 depicts a table showing calculated entropy and zero-point energy corrections (ΔE_{ZPE}) in determining the free energy of molecular O₂, H₂O, and H₂ and the adsorbed intermediates associated with FeO₄, FeO₄/(FeO₆)₂, and FeO₄/(FeO₆)₂/LFP models.

FIG. 31 depicts a table showing Gibbs free energy of OH* (ΔG_{OH*}), d-band center energy value (E_{d}), and theoretical overpotential (ηₜₕₑₒ) of FeN₄, FeN₄/Fe₄, FeO₄, FeO₄/(FeO₆)₂, and FeO₄/(FeO₆)₂/LFP models.

FIG. 32 depicts (A) top- and side-views of modelling structures and (B) projected density of states (pDOS) of FeN₄, FeN₄/(FeO₆)₂, and FeN₄/(FeO₆)₂/LFP on graphene slabs. (C) The corresponding free energy diagrams for ORR at U=1.23 V, pH=0.

FIG. 33 depicts long-term discharging curve of LFP-1 at a constant current density of 20 mA cm⁻² in an ammonia FC.

FIG. 34 depicts (A) charge (top) and discharge (bottom) curves of LFP-1 and commercial Pt/C+RuO₂ catalyst at the current densities between 10 and 50 mA cm⁻². (B) Long-term charge/discharge cycling performances of rechargeable ZABs fabricated using LFP-1 and commercial Pt/C as the cathode.

### DETAILED DESCRIPTION

### Definitions

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

As used herein, the term “isolated” in connection with an electrocatalyst described herein means the electrocatalyst is separated from some or all of the components and/or impurities that typically accompany and/or are present during its synthesis.

As used herein, the term “substantially pure” in connection with a sample of an electrocatalyst described herein means the sample contains at least 60% by weight of the electrocatalyst. In certain embodiments, the sample contains at least 70% by weight of the electrocatalyst; at least 75% by weight of the electrocatalyst; at least 80% by weight of the electrocatalyst; at least 85% by weight of the electrocatalyst; at least 90% by weight of the electrocatalyst; at least 95% by weight of the electrocatalyst; or at least 98% by weight of the electrocatalyst.

The present disclosure provides a method of preparing an electrocatalyst, the method comprising: providing an electrode material obtained from a lithium-ion battery, wherein the electrode material comprises LiFePO₄@N-doped carbon core-shell particles; contacting the electrode material with an aqueous solution comprising an acid thereby forming the electrocatalyst; and optionally drying the electrocatalyst.

Lithium-ion batteries useful in the methods described herein can be batteries used in electronic devices, such as laptops, computers, smartphones, and any other electronic devices that use batteries containing electrode material comprising LiFePO₄@N-doped carbon core-shell particles; and automobiles, such as hybrid and electric. Lithium-ion batteries from such electronic devices and automobiles can be exhausted, at least partially or fully depleted, and/or damaged.

The lithium-ion batteries can be physically dismantled to obtain crude electrode material comprising the LiFePO₄@N-doped carbon core-shell particles used in the methods described herein. The crude electrode material can be used directly in the methods described herein or can optionally be purified prior to use. The crude electrode material can comprise one or more impurities selected from the group consisting of a binder (e.g., polyvinylidene fluoride (PVDF)) and one or more volatile organic solvents (e.g., N-methyl-2-pyrrolidone alkyl carbonates (e.g., propylene carbonate and ethylene carbonate, dialkyl carbonates, cyclic ethers, cyclic esters, glymes, lactones, formates, esters, sulfones, nitrates, and oxazoladinones). Thus, in certain embodiments, the method described herein can further comprise one more purification steps selected from solid-liquid extraction and drying.

In certain embodiments, the method described herein further comprises extracting the crude electrode material with an organic solvent thereby removing at least a portion of the binder from the untreated electrode material. The organic solvent can comprise a cyclic carbonate, such as ethylene carbonate, propylene carbonate, and vinylene carbonate; an acyclic carbonate, such as dimethyl carbonate, diethyl carbonate, ethyl methyl carbonate, and the like; cyclic esters, such as γ-butyrolactone; acyclic esters, such as methyl acetate; cyclic ethers, such as tetrahydrofuran, tetrahydropyran, dioxane, and the like; acyclic ethers, such as 1,2-dimethoxyethane and 1,2-diethoxyethane; a lactam, such as 1-methyl-2-pyrrolidone; a dialkyl sulfoxide, such as dimethyl sulfoxide; dimethylformamide; and mixtures thereof.

In certain embodiments, the method described herein further comprises drying the untreated electrode material thereby removing at least a portion of the one or more volatile organics from the untreated electrode material. The step of drying the untreated electrode material can be accomplished using any methods in the art, such as by vacuum drying, air-drying, sun drying, spray drying, infrared radiation drying, microwave drying, convection drying, warm forced air, freeze-drying, and combinations thereof. In certain embodiments, the electrocatalyst is freeze-dried.

The particle size of the electrode material can optionally be reduced prior to use in the methods described herein.

There are various known methods for controlling the particle size of substances, including reduction by comminution or de-agglomeration by milling and/or sieving. Exemplary methods for particle reduction include, but are not limited to jet milling, hammer milling, compression milling and tumble milling processes (e.g., ball milling). Particle size control parameters for these processes are well understood by the person skilled in the art. For example, the particle size reduction achieved in a jet milling process is controlled by adjusting a number of parameters, the primary ones being mill pressure and feed rate. In a hammer mill process, the particle size reduction is controlled by the feed rate, the hammer speed and the size of the opening in the grate/screen at the outlet. In a compression mill process, the particle size reduction is controlled by the feed rate and amount of compression imparted to the material (e.g., the amount of force applied to compression rollers).

The shape of the LiFePO₄@N-doped carbon core-shell particles is not particularly limited. In certain embodiments, the LiFePO₄@N-doped carbon core-shell particles are rod shaped, spherical, irregularly shaped, or a mixture thereof.

The acid can be any strong acid. Exemplary acids include, but are not limited to HCl, HBr, HI, H₂SO₄, M^{t}(HSO₄)T, or a mixture thereof, wherein t represents the charge of cation M, which can be +1 or +2; T is equal to the absolute value t; and M is Li, Na, K, Rb, Cs, Mg, Ca, or Sr. In certain embodiments, the acid is HCl.

The concentration of the acid can range from 1×10⁻⁴ M to 12M, 1×10⁻⁴ M to 11M, 1×10⁻⁴ M to 10M, 1×10⁻⁴ M to 9M, 1×10⁻⁴ M to 8M, 1×10⁻⁴ M to 7M, 1×10⁻⁴ M to 6M, 1×10⁻⁴ M to 5M, 1×10⁻⁴ M to 3M, 1×10⁻³ M to 3M, 0.01M to 3M, 0.1M to 3M, 0.5M to 3M, 1M to 3M, 1.5M to 2.5M, 1.6M to 2.4M, 1.7M to 2.3M, 1.8M to 2.2M, 1.9M to 2.1M, 0.7M to 1.3M, 0.8M to 1.2M, or 0.9M to 1.1M. In certain embodiments, the concentration of the acid is about 2M.

The aqueous solution can have a pH less than 4, less than 3, less than 2, less than 1, less than 0, or less than −1. In certain embodiments, the pH of the aqueous solution is between −2 to 4, −1 to 4, −1 to 3, −1 to 2, −1 to 1, −1 to 0.5, −1 to 0, 0 to 0.5, 0.1 to 0.5, 0.2 to 0.5, or 0.2 to 0.4. In certain embodiments, the pH of the aqueous solution is about 0.3.

The aqueous solution and the electrode material can be contacted at 0.01-10 mg, 0.01-9 mg, 0.01-8 mg, 0.01-7 mg, 0.01-6 mg, 0.01-5 mg, 0.01-4 mg, 0.01-3 mg, 0.01-2 mg, 0.01-1 mg, 0.01-0.9 mg, 0.01-0.8 mg, 0.01-0.7 mg, 0.01-0.6 mg, 0.01-0.5 mg, 0.01-0.4 mg, 0.01-0.3 mg, 0.01-0.2 mg, 0.05-0.15 mg, 0.06-0.14 mg, 0.07-0.13 mg, 0.08-0.12 mg, or 0.09-0.11 mg of electrode material per mL of aqueous solution. In certain embodiments, the aqueous solution and the electrode material are contacted at about 0.1 mg of electrode material per mL of aqueous solution.

The amount of time the electrode material and the aqueous solution remain in contact generally depends on several parameters, such as type of acid used, the concentration of the acid, the concentration of the electrode material in the aqueous solution, and the temperature of the aqueous solution. The selection of the appropriate reaction time is well within the skill of a person of ordinary skill in the art. In certain embodiments, the electrode material and the aqueous solution remain in contact for 5-240 minutes, 10-240 minutes, 5-210 minutes, 5-180 minutes, 5-150 minutes, 5-120 minutes, 5-90 minutes, 5-60 minutes, 5-50 minutes, 5-40 minutes, 5-30 minutes, 5-20 minutes, 5-15 minutes, 6-14 minutes, 7-13 minutes, 8-12 minutes, or 9-11 minutes. In certain embodiments, the electrode material and the aqueous solution remain in contact for about 10 minutes.

The step of contacting the electrode material and the aqueous solution can be conducted at 20-60° C., 20-50° C., 20-40° C., 20-30° C., or 22-26° C. In certain embodiments, the step of contacting the electrode material and the aqueous solution is conducted at room temperature.

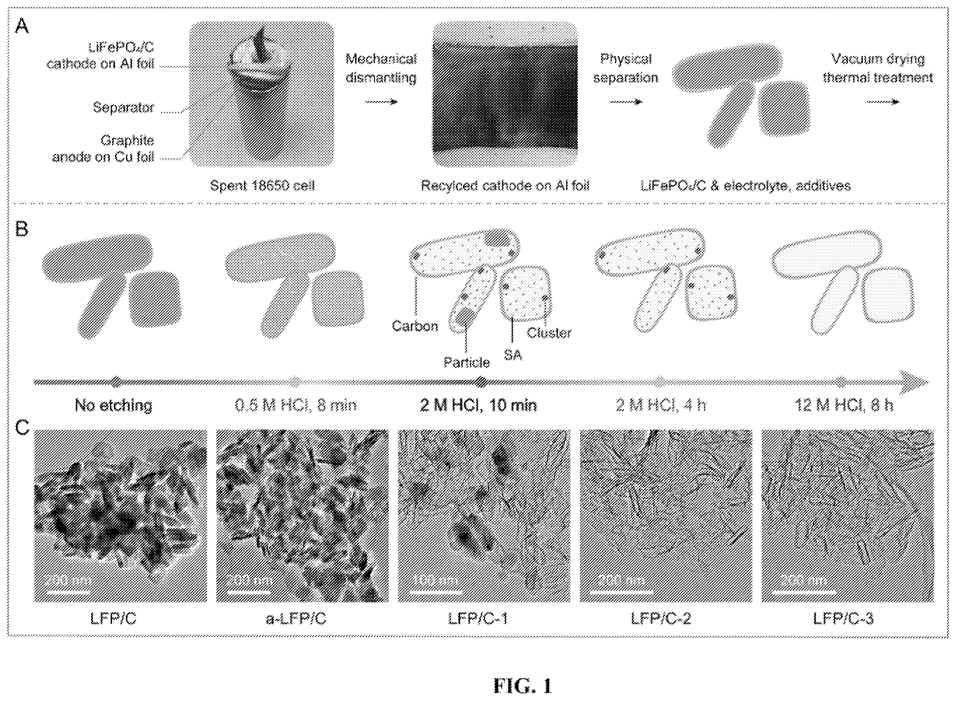

The electrocatalyst prepared in accordance with the methods described herein can be rod shaped, spherical, irregularly shaped, or a mixture thereof. As illustrated in FIG. 1, treatment of LiFePO₄@N-doped carbon core-shell particles with an aqueous solution comprising an acid can selectively etch and extract at least a portion of the LiFePO₄ in the LiFePO₄@N-doped carbon core-shell particles leaving substantially hollow N-doped carbon core-shell particles comprising one or more iron species selected from single atoms of Fe embedded in the N-doped carbon core-shell particles, FeO, FeO clusters, and mixtures thereof. In certain embodiments, the N-doped carbon core-shell particles comprises residual LiFePO₄.

The electrocatalyst can have a total iron (e.g., in the form of one or more of Fe embedded in the N-doped carbon core-shell particles, FeO, FeO clusters, optionally LiFePO₄, and mixtures thereof) concentration of 1-10 wt. %, 1-9 wt. %, 1-8 wt. %, 1-7 wt. %, 1-6 wt. %, 1-5 wt. %, 1-4 wt. %, 2-4 wt. %, 2.63-3.71 wt. %, 2.3-2.9 wt. %, 2.4-2.8 wt. %, 2.5-2.7 wt. %, 3.4-4.0 wt. %, 3.5-3.9 wt. %, or 3.6-3.8 wt. %. In certain embodiments, the total concentration of iron in the electrocatalyst is about 2.63 wt. % or about 3.71 wt. %

The electrocatalyst can have a BET surface area between 500-800 m² g⁻¹, 500-700 m² g⁻¹, 500-500 m² g⁻¹, 500-550 m² g⁻¹, 500-540 m² g⁻¹, 500-530 m² g⁻¹, 510-520 m² g⁻¹, 600-800 m² g⁻¹, 700-800 m² g⁻¹, 700-790 m² g⁻¹, 700-780 m² g⁻¹, 700-770 m² g⁻¹, 710-770 m² g⁻¹, 710-760 m² g⁻¹, 720-750 m² g⁻¹, or 730-750 m² g⁻¹. In certain embodiments, the electrocatalyst has a BET surface area of about 515.9 m² g⁻¹ or about 742.3 m² g⁻¹.

The electrocatalyst can optionally be dried using any method known to those skilled in the art, such as by application of heat and/or exposing the electrocatalyst to reduced pressure. In certain embodiments, the electrocatalyst is dried by vacuum drying, air-drying, sun drying, spray drying, infrared radiation drying, microwave drying, convection drying, warm forced air, freeze-drying, and combinations thereof. In certain embodiments, the electrocatalyst is freeze-dried.

The present disclosure also provides an electrocatalyst prepared in accordance with the methods described herein. In certain embodiments, the electrocatalyst is isolated and/or substantially pure.

An electrochemical cell comprising: an electrode comprising the electrocatalyst described herein; a counter electrode; optionally a reference electrode; and an electrolyte.

The present disclosure also provides the use of an electrocatalyst prepared in accordance with the methods described herein in an electrocatalytic reduction reaction.

In certain embodiments, the methods described herein further comprise depositing or affixing the electrocatalyst on a surface of a metal substrate and combining the electrocatalyst with an electrolyte.

Any electrolyte known in the art can be used in the methods described herein. In certain embodiments, the electrolyte is a non-aqueous liquid electrolyte or an organic solid electrolyte,

The non-aqueous liquid electrolyte can comprise at least one electrolyte solvent selected from propylene carbonate, ethylene carbonate, butylene carbonate, dimethyl carbonate (DMC), diethyl carbonate, methyl ethyl carbonate (MEC), fluoroethylene carbonate (FEC), γ-butyrolactone, methyl formate, methyl acetate, 1,2-dimethoxyethane, tetrahydrofuran, 2-methyltetrahydrofuran, dimethyl sulfoxide, 1,3-dioxolane, formamide, dimethylformamide, dioxane, acetonitrile, nitromethane, ethyl monoglyme, phosphoric triesters, trimethoxymethane, dioxolane derivatives, sulfolane, 3-methyl-2-oxazolidinone, propylene carbonate derivatives, tetrahydrofuran derivatives, ethyl ether, 1,3-propanesultone, N-methyl acetamide, acetonitrile, acetals, ketals, sulfones, sulfolanes, aliphatic ethers, cyclic ethers, glymes, polyethers, phosphate esters, siloxanes, dioxolanes, and N-alkylpyrrolidones. In certain embodiments, the non-aqueous liquid electrolyte comprises EC, DMC, DEC, EMC, FEC, and combinations thereof.

Non-limiting examples of the organic solid electrolyte are polyethylene derivatives, polyethylene oxide derivatives, polypropylene oxide derivatives, phosphoric acid ester polymers, poly agitation lysine, polyester sulfide, polyvinyl alcohols, polyvinylidene fluoride, and polymers containing ionic dissociation groups.

In certain embodiments, the electrolyte comprises a proton exchange membrane (PEM). An exemplary PEM is sulfonated tetrafluorethylene and perfluorovinylether copolymer sold under the tradename Nafion™.

The method described herein can further comprise affixing the electrocatalyst to a current collector. The current collector can be a positive current collector or a negative current collector.

The negative electrode current collector may be any material having a conductivity without causing a chemical change in the lithium battery, for example, copper, stainless steel, aluminum, nickel, titanium, sintered carbon, or copper or stainless steel of which a surface is treated with carbon, nickel, titanium, silver, or the like, or an aluminum-cadmium alloy. Additional exemplary negative electrode current collectors include, but are not limited to copper foil, copper mesh foil, copper foam sheets, nickel foam sheets, nickel mesh foil, and nickel foil. In some embodiments, the negative electrode current collector may be in any of various forms, including a film, a sheet, a foil, a net, a porous structure, foam, and non-woven fabric.

The positive electrode current collector may be any material having a high conductivity without causing a chemical change in the lithium battery, for example, stainless steel, aluminum, nickel, titanium, sintered carbon, or aluminum or stainless steel of which a surface is treated with carbon, nickel, titanium, silver, or the like. In certain embodiments, the positive electrode current collector may have fine irregularities on a surface thereof so as to have enhanced adhesive strength to the positive active material. The positive electrode current collector may be in any of various forms, including a film, a sheet, a foil, a net, a porous structure, foam, and non-woven fabric.

Upcycling Process and Structural Analysis of LFP/C Samples

FIG. 7 illustrates the overall recycling process of end-of-life lithium iron phosphate batteries. The cathode material, LiFePO₄ encased in N-doped carbon layers (denoted as LFP/C), was first recovered by mechanical dismantling and physical separation under an inert environment (FIG. 1A), followed by solvent rinsing, vacuum drying, and thermal treatment. The binder components, such as PVDF, are removed during rinsing, while volatile organics, such as N-methyl-2-pyrrolidone and (di)ethylene carbonate, are evaporated at a relatively low temperature (<150° C.) during thermal treatment. The collected LFP/C was then immersed in HCl for partial etching. The majority of metal contents (Li and Fe) that leached into the solution could be reclaimed by further processing such as solvent extraction and selective precipitation. The residual precipitate was collected by filtration and freeze-dried. A series of conditions were set to determine the dissolution efficiency of the partial etching treatment, including HCl concentration, reaction temperature, and reaction time. As illustrated in FIG. 1B, five samples, unetched LFP/C, LFP/C treated with 0.5 M HCl for 8 min, 2 M HCl for 10 min and 4 h, and 12 M HCl for 8 h (HCl-to-sample ratio=10 mL:1 mg; 25° C.), are selected as the representative examples of various leaching stages.

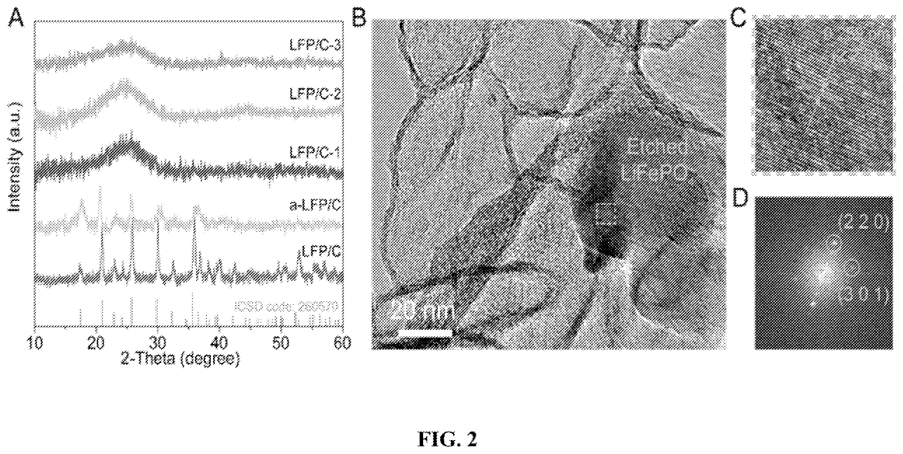

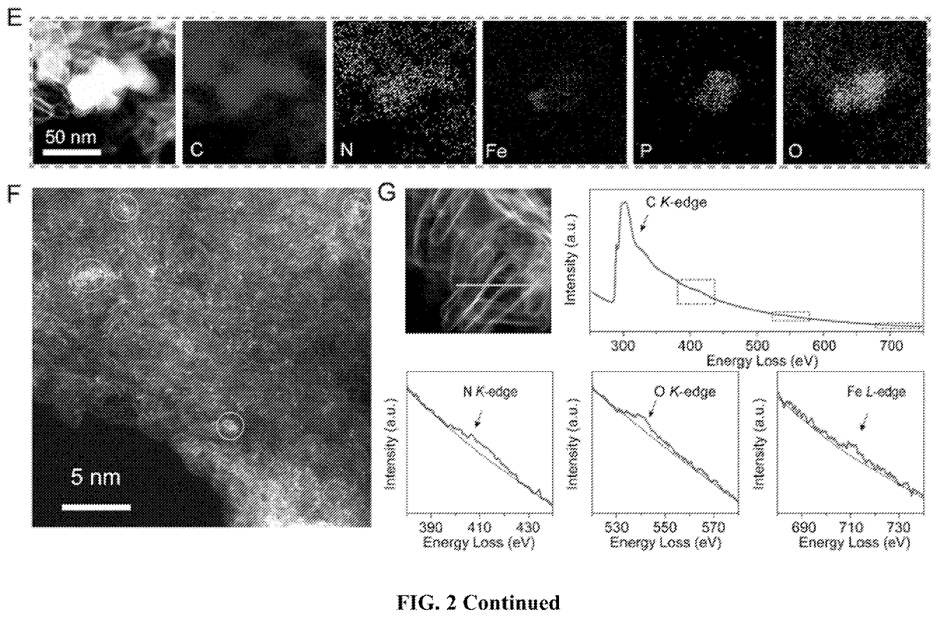

The structural and morphologic evolution of LFP/C during the acid treatment was first investigated using a combination of powder X-ray diffraction (XRD), SEM, and TEM. The pristine LFP/C exhibits a typical XRD pattern of triphylite phase (ICSD code: 260570, FIG. 2A), confirming the presence of LFP as the only crystalline phase. The SEM and TEM images in FIGS. 1C, 8a, and S3 show the ellipsoidal LFP particles wrapped with thin carbon layers (thickness=ca. 4 nm) in a core-shell structure. A short (8 min) treatment of LFP/C in 0.5 M HCl (denoted as a-LFP/C) leads to peak broadening and reduced intensity in the XRD pattern, which is indicative of structural disorder. Although a-LFP/C has a similar morphology as the pristine LFP/C (FIG. 8b), its high-resolution TEM images (FIGS. 1C and 10) reveal the amorphization of LFP particles. When treated with more concentrated HCl for longer periods (2 M HCl for 10 min and 4 h, denoted as LFP/C-1 and LFP/C-2, respectively), all XRD peaks disappear, suggesting the decomposition of the crystalline LFP core, and a broad peak from carbon matrix emerges at ca. 25°, which corresponds to the (002) plane of graphite. The decomposition and dissolution of the LFP core by acid treatment causes the deflation of carbon shells as evidenced by the wrinkled surface in SEM images (FIGS. 8c and 8d). The TEM images in FIG. 1C reveal hollow carbon shells of LFP/C-1 and LFP/C-2. In LFP/C-1, however, residual particles still remain due to incomplete etching. LFP/C-3 was prepared using more severe leaching conditions by refluxing LFP/C in hot concentrated HCl (12 M) for 8 h. Open cracks are apparent over the entire carbon shells of LFP/C-3 (FIG. 8e), which suggest the corrosion of the carbon sphere under harsh conditions.

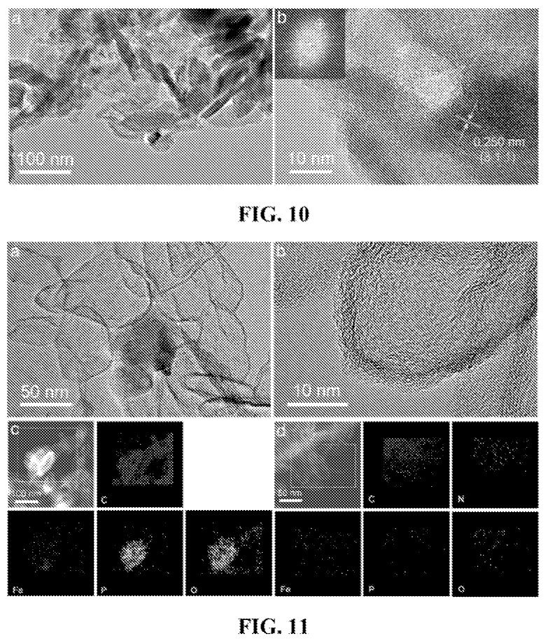

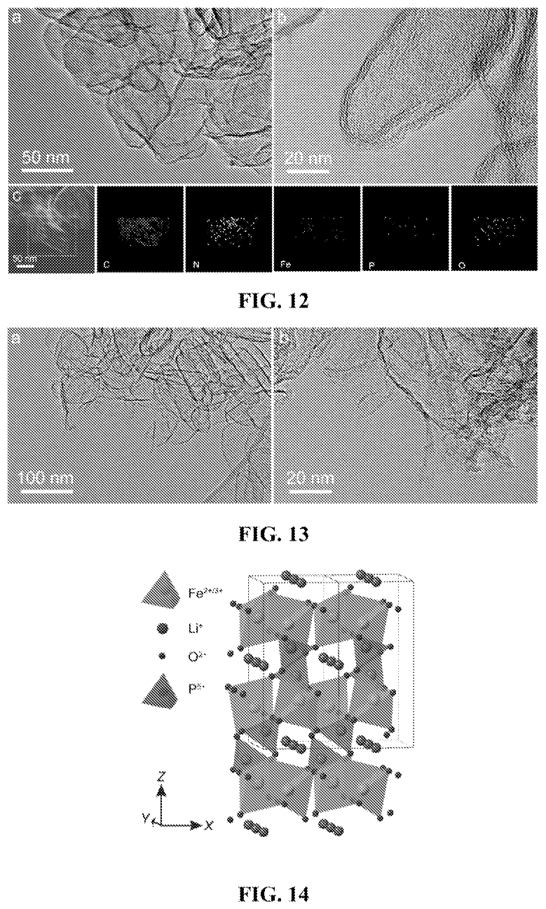

The microstructure of the acid-etched LFP/C samples was probed by high-resolution TEM. FIGS. 2B and 11 unveil that majority of the crystalline LFP is removed from LFP/C-1 with a few irregular particles remaining. On the contrary, both LFP/C-2 and LFP/C-3 exhibit a morphology of hollow carbon spheres without any visible metal particles (FIGS. 12 and 13). The magnified TEM image (FIG. 2C) and fast Fourier transform (FFT) pattern (FIG. 2D) acquired on the [11̅3]-orientated crystal in LFP/C-1 show the (220) and (301) reflections of triphylite phase. FIGS. 2E and 11c are representative high-angle annular dark-field scanning transmission microscopic (HAADF-STEM) images and elemental mapping images of two regions of LFP/C-1 acquired by energy-dispersive X-ray spectroscopy (EDX), which provide a semi-quantitative compositional analysis. The Fe signal covers a much smaller area (d=ca. 20 nm) of the residual particle compared with P and O signals (d=ca. 50 nm), which contrasts with the pristine LFP particles that display similar areas for Fe, P, and O elements. The removal of Fe atoms from the initial LFP crystal structure may result from the weaker M—O bond than the covalent P—O bond. Meanwhile, no signal is detected from Li because of its light mass. Considering its high reactivity and easy delithiation, Li atoms are most likely etched away by HCl. It is believed that during the acid treatment, Li⁺ and Fe^{2+/3+} are first removed from LiO₆ and FeO₆ octahedra of the olivine structure (FIG. 14) by reacting with H⁺ and dispersed to the solution, followed by slower dissolution of PO₄ tetrahedra.

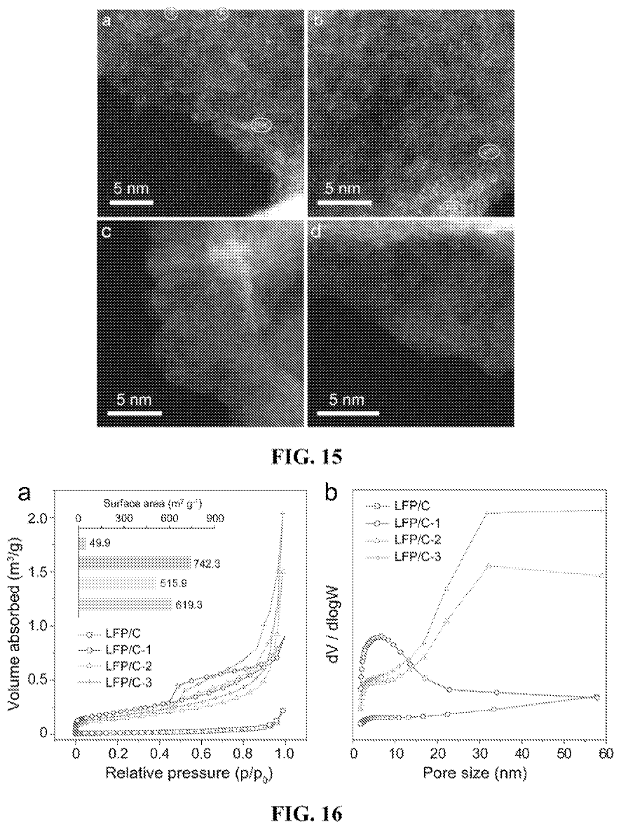

Under mild etching conditions, the decomposition of LFP particles is incomplete, and we speculated that species other than the residual LFP may remain in the carbon shell of LFP/C-1. To get atomic-resolution images of LFP/C-1, we employed aberration-corrected HAADF-STEM (FIGS. 2F and 15). Most Fe sites appear as isolated bright dots, indicating that they are embedded as single atoms (SA_{Fe}) in the carbon shell. In addition, several aggregated dots (circles; d<2 nm) are identified, suggesting the co-existence of nanoscale clusters. The chemical composition of LFP/C-1 was further analyzed by electron energy-loss spectroscopy (EELS, FIG. 2G) at a spatial resolution of sub-nanometer. The line scanning profile recorded across a hollow N-doped carbon sphere displays the main peak at ca. 300 eV and a minor loss peak at ca. 410 eV, which correspond to C and N K-edges, respectively. The presence of 0 and Fe atoms is confirmed by two minor loss peaks at ca. 540 and 710 eV, respectively. Again, Li K-edge (ca. 50 eV) is not observed because of its extremely low content. The P L-edge (ca. 130 eV) is also absent due to the removal of PO₄ from the hollow carbon layer. Combined with the electron microscopic analyses, these spectroscopic results suggest that 1) isolated Fe atoms observed in FIG. 2F are bonded with O atoms in the surroundings and are further in contact with the N-doped carbon matrix and 2) nanoscale FeO clusters are also present.

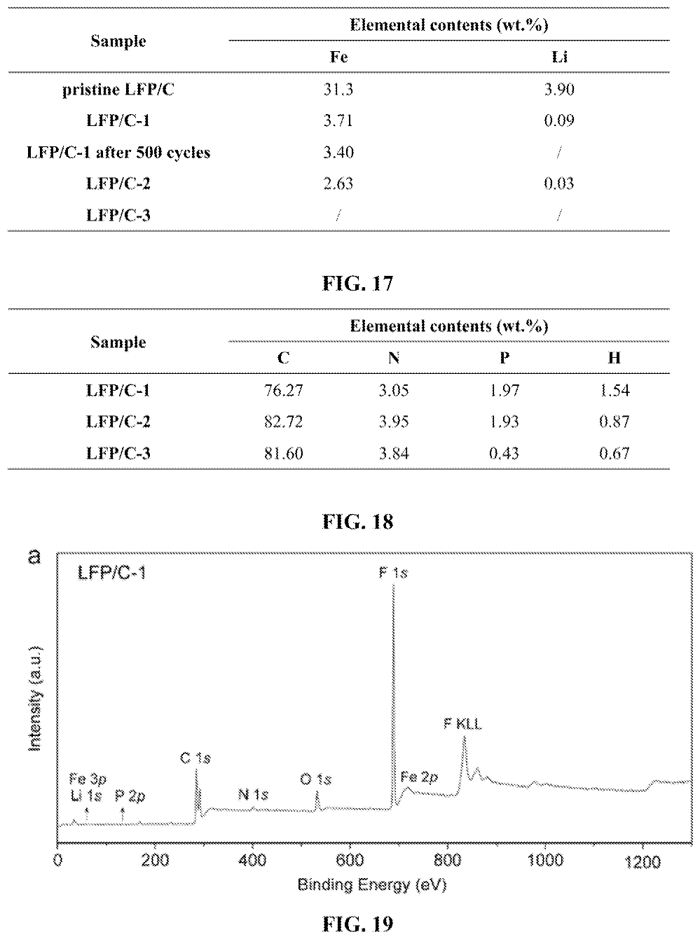

Inductively coupled plasma optical emission spectrometry (ICP-OES, FIG. 17) and elemental analysis (FIG. 18) were conducted to qualitatively determine the compositional differences among LFP/C-1, LFP/C-2, and LFP/C-3. Notably, the total Fe and Li loading amounts in LFP/C-1 are found as 3.71 and 0.09 wt. %, while LFP/C-2 contains 2.63 and 0.03 wt. % of Fe and Li, respectively. No detectable metal signals are found in LFP/C-3. Despite that LFP/C-2 and LFP/C-3 show very similar structural and morphological features, it is suggested that a trace amount of Fe species still exists in LFP/C-2 (FIGS. 15c and 15d) while almost no Fe remains in LFP/C-3.

The acid treatment of LFP/C creates voids in the carbon sphere, thereby increasing surface area and porosity. The N₂ adsorption—desorption isotherms and the corresponding pore volume distribution plots (FIG. 16) suggest the mesoporous nature of the etched LFP/C samples. The Brunauer-Emmett-Teller (BET) surface area of LFP/C-1 is 742.3 m² g⁻¹, followed by LFP/C-3 (619.3 m² g⁻¹) and LFP/C-2 (515.9 m² g⁻¹), all of which are significantly higher than that of LFP/C (49.9 m² g⁻¹). Pore size analysis indicates that LFP/C-1 possesses a large amount of mesopores with diameters between 2 and 15 nm, whereas LFP/C-2 and LFP/C-3 have larger pores (d=20-60 nm).

Spectroscopic Analysis of LFP/C Samples

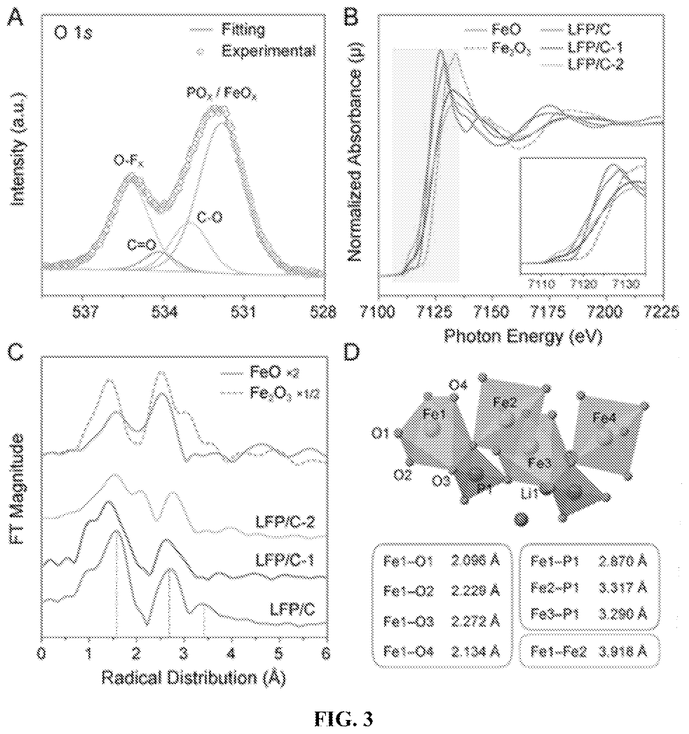

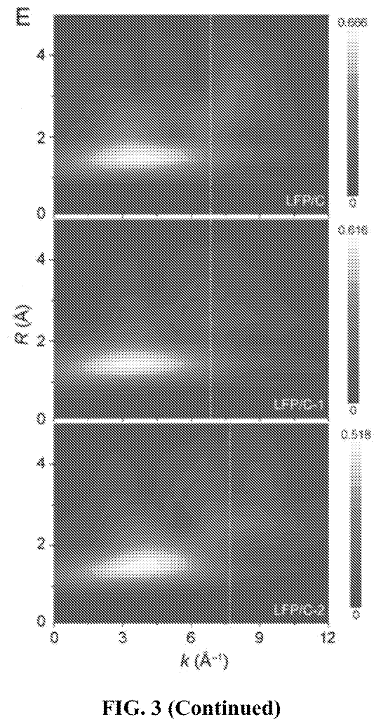

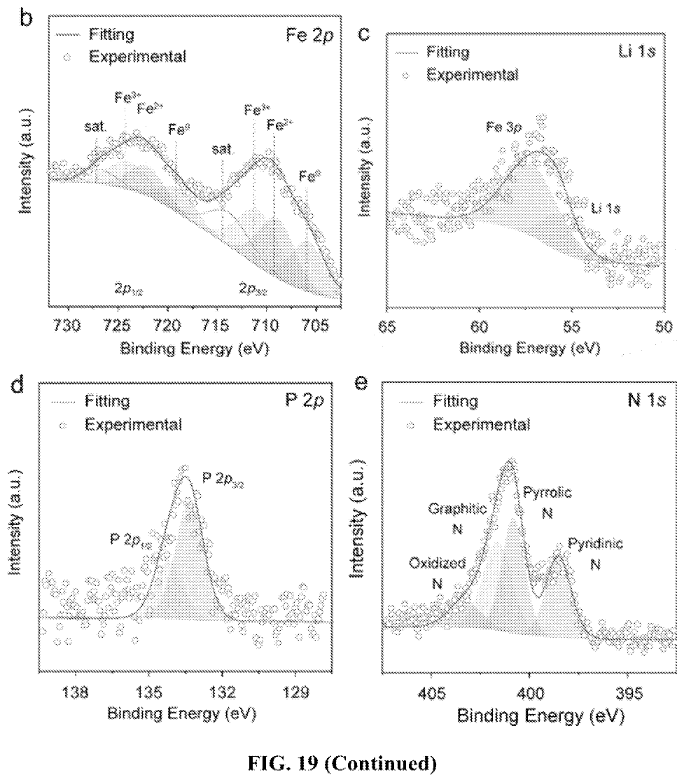

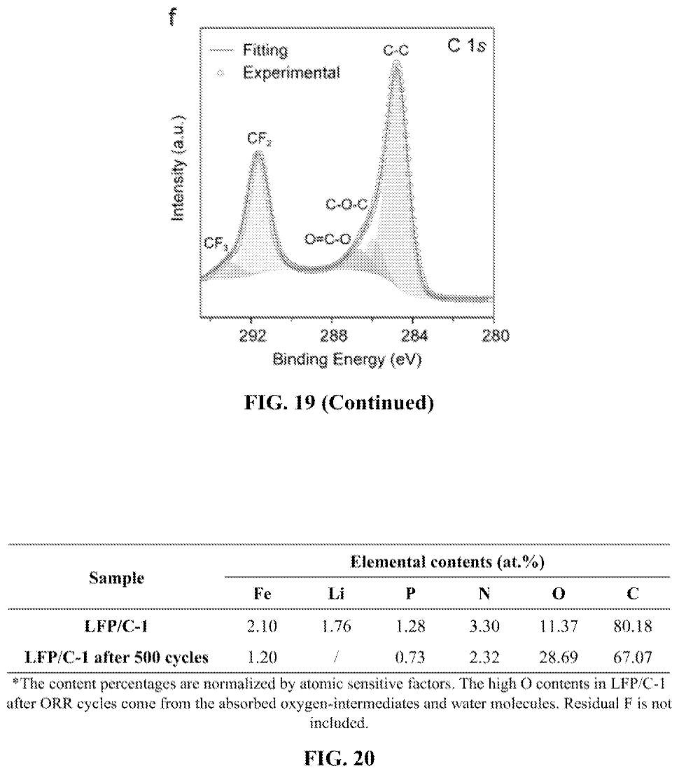

X-ray photoelectron spectroscopy (XPS) was engaged to investigate the chemical state of surface species in LFP/C-1 (FIG. 19). The survey XPS spectrum verifies the presence of all elements of LFP and N-doped carbon, and the F signal originates from the residual binder (PVDF). The high-resolution Fe 2p spectrum in FIG. 19b shows two sets of spin-orbit doublets (Fe 2p_{3/2} and Fe 2p_{1/2}) that are composed of two Fe′ peaks at the binding energy of 709.2 and 722.3 eV and two Fe³⁺ peaks at 711.3 and 724.4 eV as well as metallic Fe⁰ species at 706.0 and 719.3 eV. The surface contents of Fe in the LFP/C-1 are ca. 3.6 wt. % (FIG. 20), which is consistent with the result of ICP-OES (ca. 3.7 wt. %). A small Li is peak is observed at 55.9 eV, which overlaps with Fe 3p signal (57.5 eV, FIG. 19c). The P 2p spectrum of LFP/C-1 is deconvoluted to two P 2p peaks of P 2p_{3/2} and P 2p_{1/2} at 133.4 and 134.2 eV, respectively (FIG. 19d). Four peaks are identified from the N is spectrum (FIG. 19e), which are assigned to pyridinic N (398.6 eV), pyrrolic N (400.8 eV), graphitic N (401.6 eV), and oxidized N species (403.3 eV). The O 1s spectrum (FIG. 3A) is dominated by lattice-oxygen signals from PO₄ and FeO₆ at 531.8 eV, followed by F—O (535.2 eV), C—O (533.0 eV), and C═O species (534.2 eV). Together with the microscopic evidence, the XPS analyses support the presence of residual LFPs, FeO clusters, and SA_{Fe} and the proposed etching mechanism.

X-ray absorption spectroscopy (XAS) was employed to further investigate the electronic structure and local coordination environment of Fe species in the etched LFP/C samples and thereby elucidate their structural evolution during the etching process. FIG. 3B shows the Fe K-edge X-ray absorption near edge structure (XANES) of pristine LFP/C, LFP/C-1, LFP/C-2, and two reference samples of FeO and Fe₂O₃. One weak pre-edge peak at ca. 7,112 eV is observed in LFP/C, which corresponds to the dipole forbidden 1s→3d transitions for octahedrally coordinated Fe sites in this sample. Besides, the 1s→4p and continuum transitions occur at ca. 7,118 eV. These characteristic pre-edge and main absorption edge features are similar to those of FeO and octahedral oxygen-coordinated Fe(II) compounds such as FeC₂O₄ and [Fe(H₂O)₆][SiF₆]), indicating that the average Fe oxidation state is +2 in LFP/C. The pre-edges in LFP/C-1 and LFP/C-2 are more intense and shifted to higher energy (ca. 7,114 eV), accompanying the positively shifted main absorption edges. All the features of LFP/C-1 and LFP/C-2 are similar to those of Fe₂O₃ and delithiated FePO₄, whose 3d and 4p electron levels are different from LFP due to the altered oxidation state, and this suggests the Fe valence states in LFP/C-1 and LFP/C-2 mainly comprise of +3.

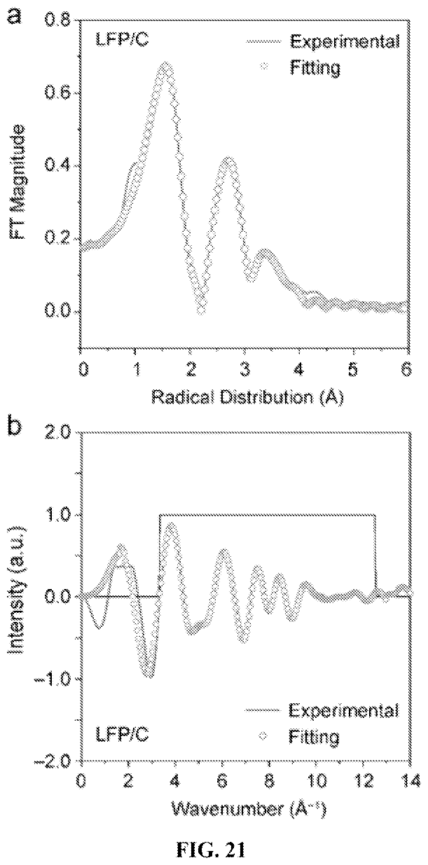

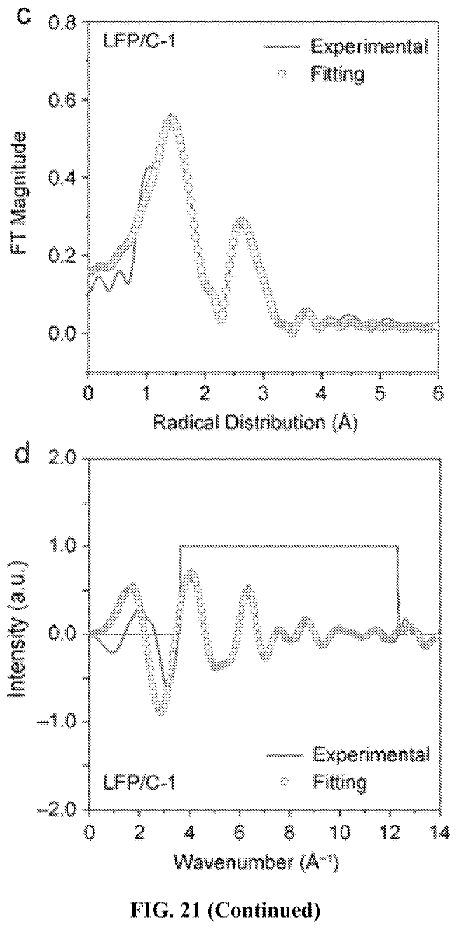

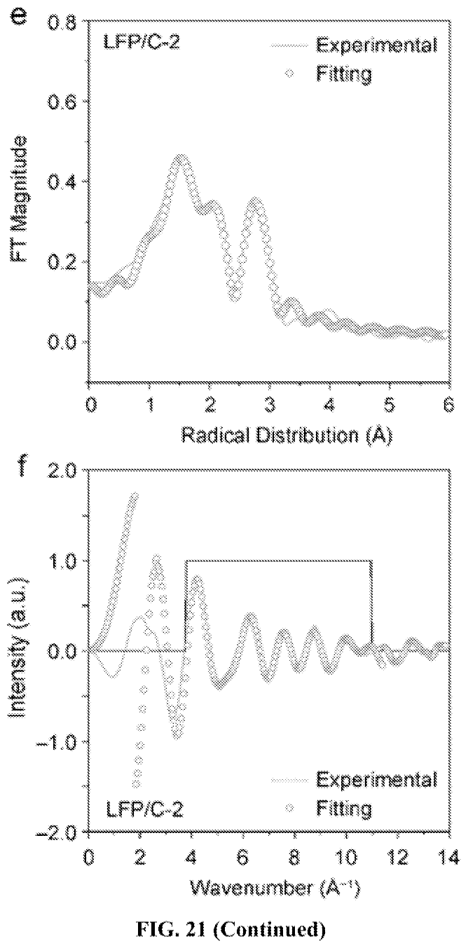

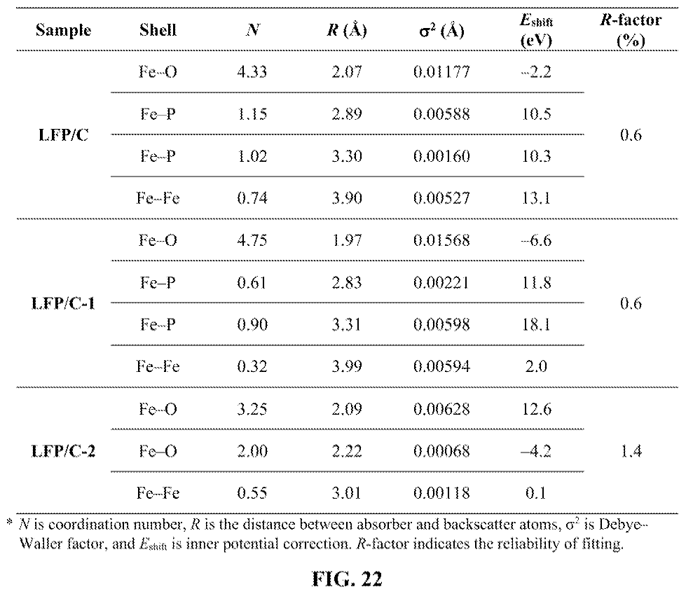

The corresponding profiles of Fourier transformed (FT) k²-weighted χ(k) function of extended X-ray absorption fine structure (EXAFS, without phase correction) are shown in FIG. 3C. The results were further fitted to investigate the coordination environments of Fe species in the samples (FIG. 21 and FIG. 22). Various radial distances between Fe and X (X═O, P, Fe, and Li) are measured in the LFP crystal structure (FIG. 3D), which offers the crystallographic basis for analyzing the scattering contribution of different atomic shells around X-ray absorbing Fe atoms. The pristine LFP/C displays the main peak at ca. 2.07 Å (after phase correction, the same below), which corresponds to the first shell of Fe—O coordination in the distorted FeO₆ octahedra. The second dominant signal is assigned to the two-shell scatterings between Fe and adjacent P atoms (ca. 2.89 and 3.30 Å), which correspond to the distances between Fe1-P1 and Fe2-P1 as shown in FIG. 3D. Besides, a relatively weak peak (ca. 3.90 Å) arises from the long-range Fe—Fe path from the adjacent FeO₆ octahedrons. The fitted coordination numbers (CN) of Fe—O, Fe—P, Fe—P, and Fe—Fe in LFP/C are 4.33, 1.15, 1.02, and 0.74, respectively.

According to the electron microscopic and XPS data, the isolated Fe sites with unsaturated coordination to the surrounding O atoms are the major Fe species in LFP/C-2, and FeO clusters exist as the minor species. This conclusion is further supported by the split first predominant peak comprising of two Fe—O paths at 2.09 and 2.22 Å (FIG. 3D), which indicates the disordered Fe environment is different from that of LFP. Its third shell at ca. 3.01 Å seems to have a similar feature to that of LFP (Fe—P, 2.89 and 3.30 Å), but it is not rigorous enough to ascribe it to the same scattering. Here, wavelet transform (WT) analysis was conducted to combine the insights into k- and R-space resolutions. The location of intensity maximum (k, R) in the WT contour plot depends on the atomic number of elements and the path distance. As shown in FIG. 3E, the peak of LFP/C-2 at high k value (ca. 7.8 Å⁻¹) displays an obvious positive shift compared with that of LFP/C (ca. 6.8 Å⁻¹). It suggests that this signal does not come from Fe—P but heavier Fe—Fe scattering in FeO clusters that have migrated and distorted during the etching process of FeO₆ octahedra.

The existence of various types of Fe species in LFP/C-1 complicates its EXAFS analysis that provides only averaged coordination information. However, the fitted results can still be rationalized based on the aforementioned microscopic and spectroscopic analyses. Basically, the FT profile of LFP/C-1 displays prevailing peaks (Fe—O, Fe—P, Fe—P, and Fe—Fe at ca. 1.97, 2.83, 3.31, and 3.99 Å, respectively) similar to those of LFP/C, arising from the main LFP residues. These peaks are, however, less intense and their CNs are much smaller (4.75, 0.61, 0.90, and 0.32, respectively) compared with the pristine LFP/C case as a result of the change in the local environment of Fe during the deconstruction of LFP crystal in LFP/C-1. The weaker signals from the nearest shell of Fe SAs and FeO clusters (e.g., Fe—O and Fe—Fe) are believed to overlap with strong signals of residual LFP.

Electrocatalytic Performance Analysis of Upcycled LFP/C Catalysts

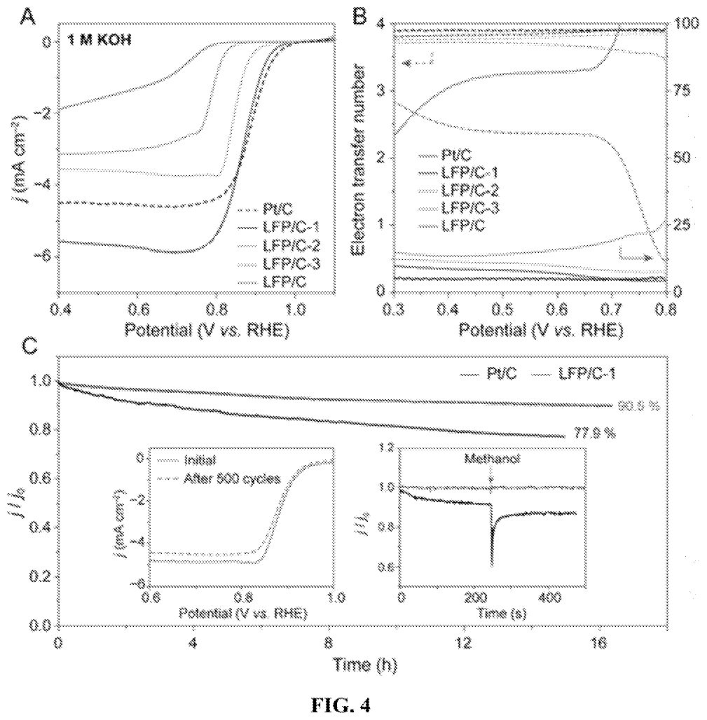

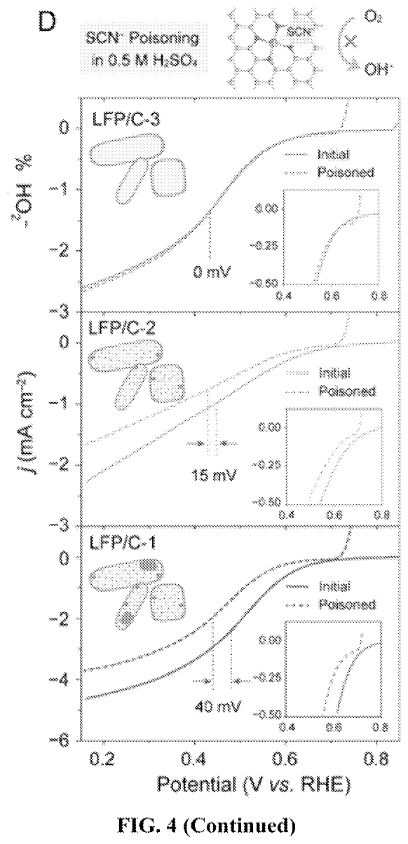

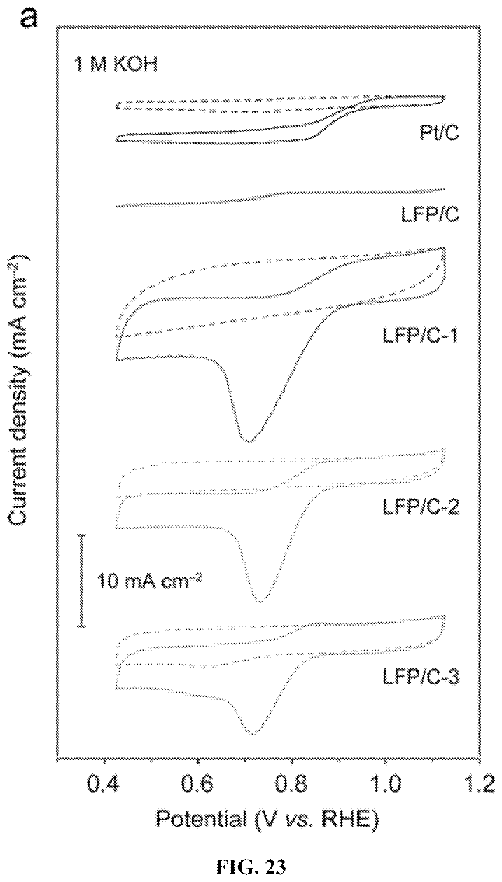

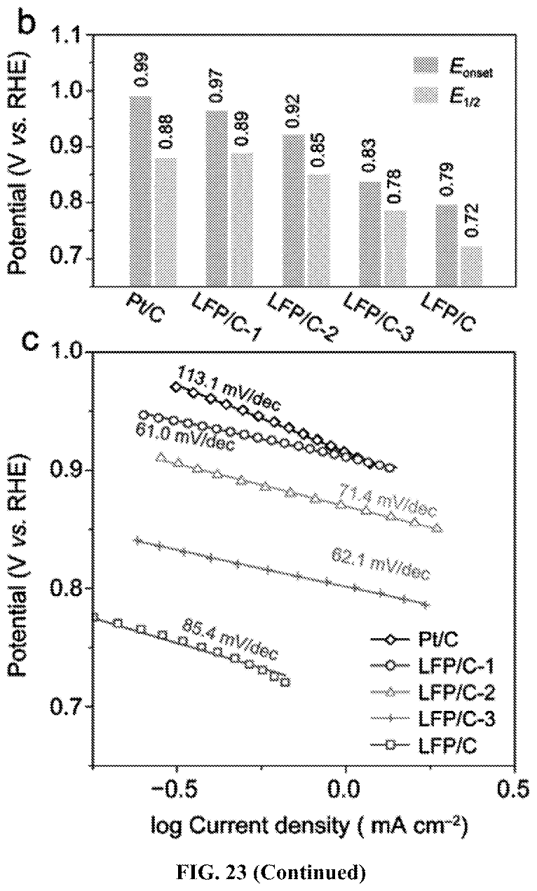

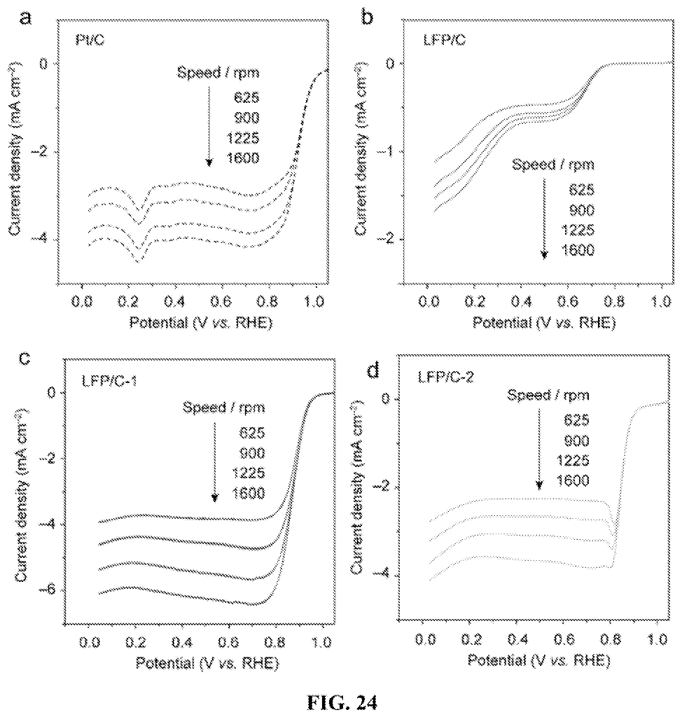

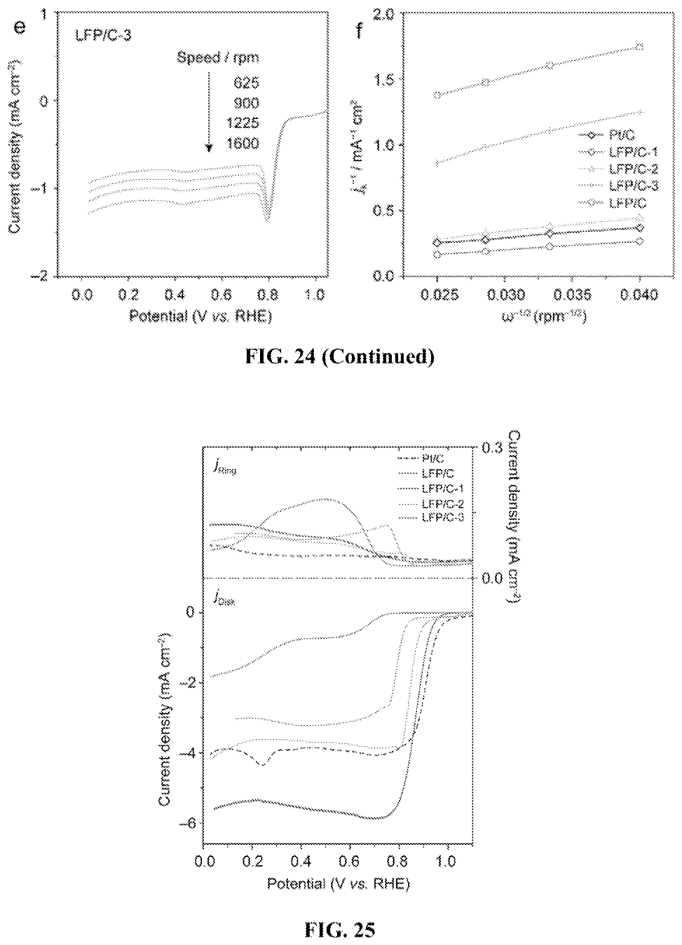

The etched LFP/C samples containing the Fe species stabilized in carbon spheres are believed to possess excellent oxygen electroreduction activity. Using a standard three-electrode cell, the electrocatalytic performances of the LFP/C catalysts and commercial Pt/C (20 wt. %) were evaluated under alkaline conditions (high purity 1 M KOH). FIG. 23a compares the cyclic voltammograms (CV) collected on a rotating disk electrode (RDE) in O₂- and Ar-saturated electrolytes, and the onset potentials (Eₒₙₛₑₜ) and half-wave potentials (E_{1/2}) are summarized in FIG. 23b. The pristine LFP/C records the lowest ORR performance with an Eₒₙₛₑₜ of merely 0.79 V vs. reversible hydrogen electrode (RHE), most probably due to the limited active metal sites exposed for the catalytic reaction. LFP/C-1 affords a very high Eₒₙₛₑₜ of 0.97 V, which is close to that of Pt/C (0.99 V), while LFP/C-2 and LFP/C-3 display lower Eₒₙₛₑₜ values of 0.92 and 0.83 V, respectively. In linear sweep voltammetry (LSV) performed using a rotating ring disk electrode (RRDE) to eliminate the mass transfer barrier (FIG. 4A), LFP/C-1 exhibits a superior ORR activity with E_{1/2} of 0.89 V, outperforming Pt/C (0.88 V), LFP/C-2 (0.85 V), LFP/C-3 (0.82 V), and LFP/C (0.72 V). In addition, the limiting current density of LFP/C-1 reaches 5.89 mA cm⁻², demonstrating much faster kinetics than the other samples. The Tafel plots obtained from polarization curves (FIG. 23c) verify such differences in the kinetic behaviors of the samples. LFP/C-1 yields the lowest Tafel slope of 61.0 mV dec⁻¹, followed by LFP/C-3 (70.5 mV dec⁻¹), LFP/C-2 (71.4 mV dec⁻¹), LFP/C (85.4 mV dec⁻¹), and Pt/C (113.1 mV dec⁻¹), which confirms the fastest kinetic process of LFP/C-1 among all samples studied. The Kouteck-Levich (K-L) plots obtained by conducting LSVs at various rotating speeds (ω) from 625 to 1,600 rpm display good linear relationships between the reciprocal current and reciprocal square root of ω for all catalysts, which are indicative of their first-order reaction process (FIG. 24).

FIG. 4B compares the calculated electron transfer number (n) and peroxide yield (% HO₂⁻) derived from the RRDE polarization curves (FIG. 25). The n value of LPF/C-1 remains larger than 3.8 in the potential window between 0.3 and 0.8 V, which is comparable to that of Pt/C. The LPF/C-1 also demonstrates a very low peroxide yield (<10%) over the entire potential range. These results confirm the superior selectivity of LFP/C-1 for the four-electron oxygen reduction path. Its analogue sample, LFP/C-2, displays a slightly inferior selectivity with a lower n (>3.7) and a higher peroxide production (<12.5%), while LFP/C-3 shows worse selectivity with n>3.5 and <25% HO₂⁻ yield. LFP/C exhibits the lowest n (ca. 2.4) and the highest % HO₂⁻ (ca. 60%), suggesting its ORR process undergoes both two- and four-electron pathways.

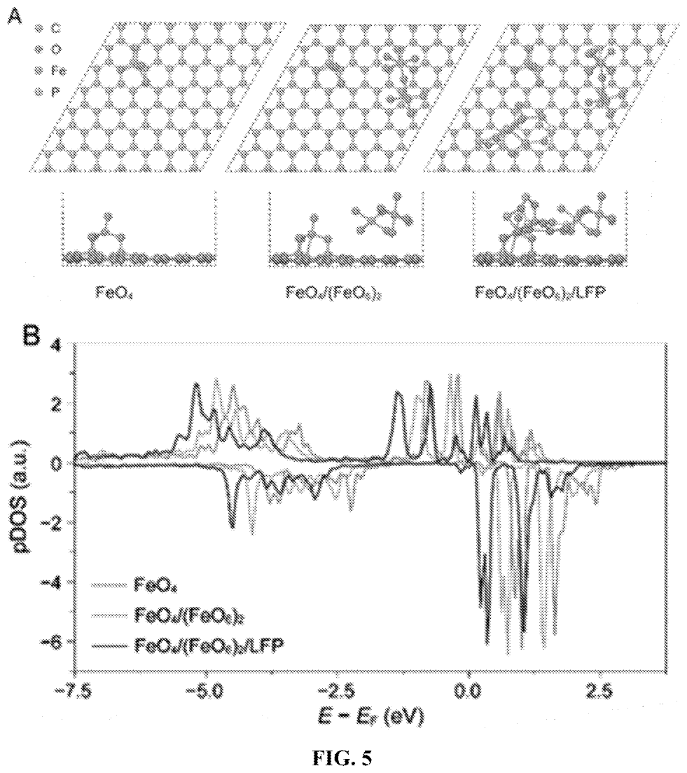

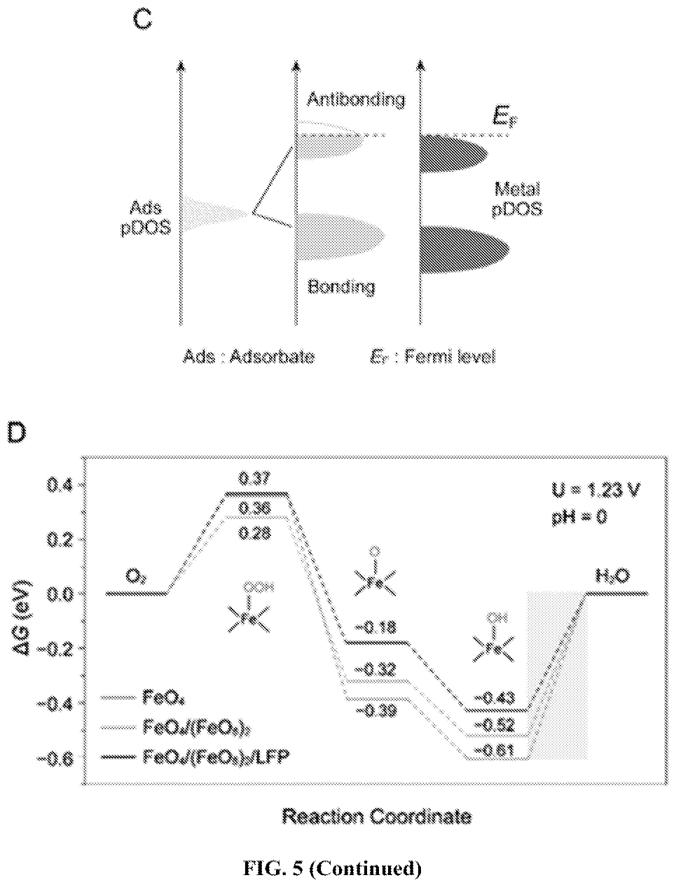

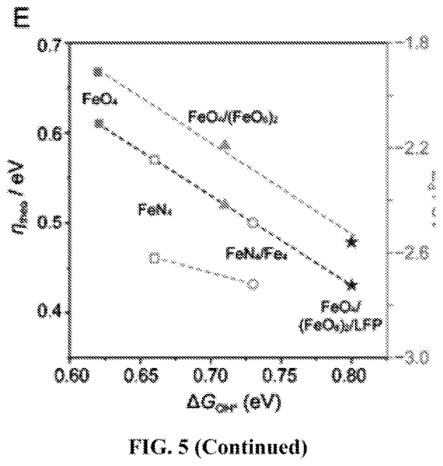

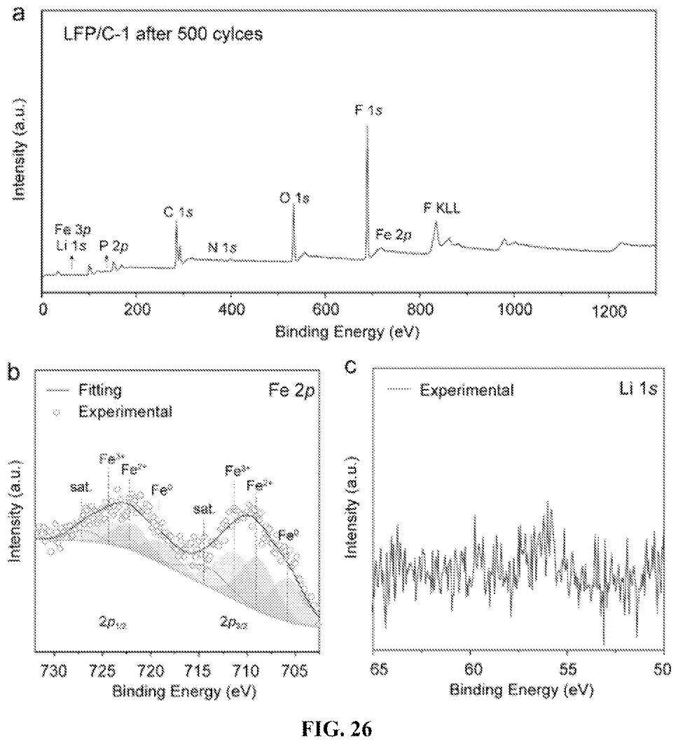

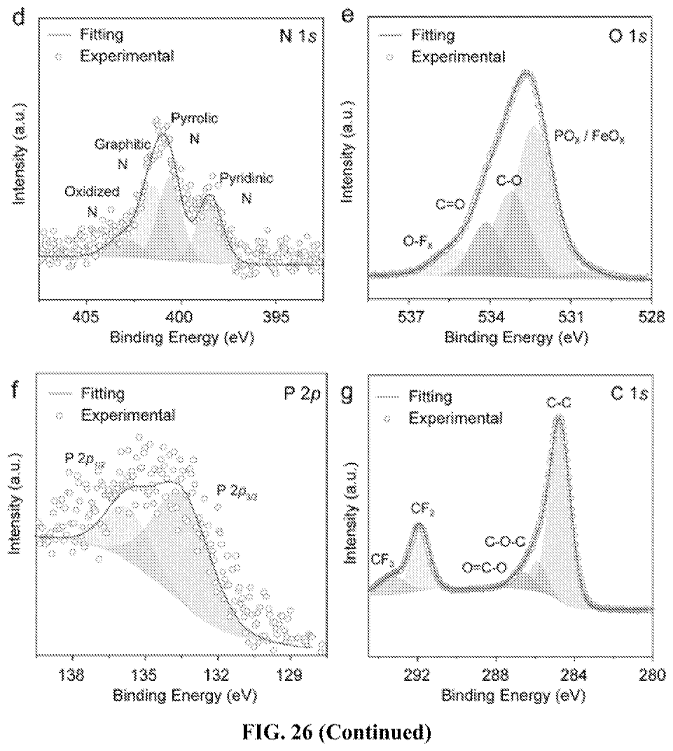

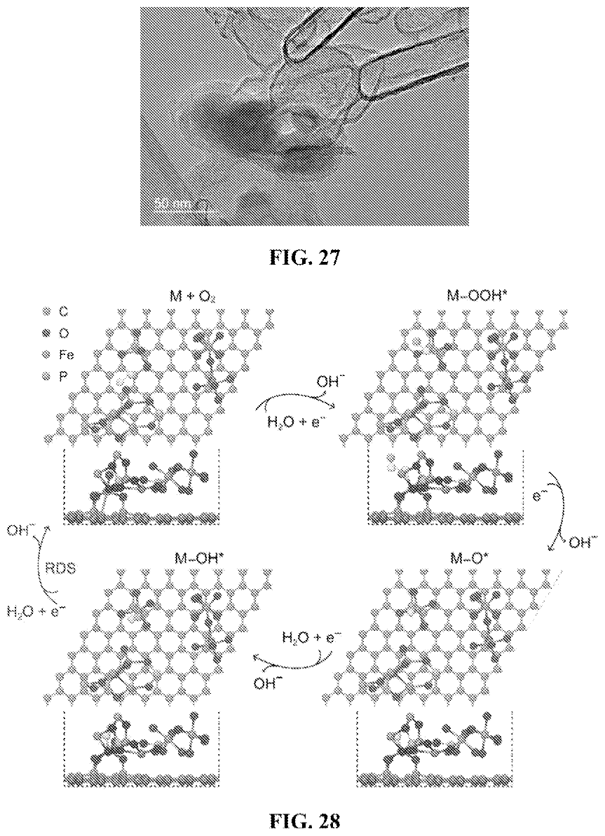

The durability of catalysts was assessed by chronoamperometric response and cycling aging tests (FIG. 5C). LFP/C-1 demonstrates good stability in a 16-h test, retaining 90.5% of the initial current density, which is much better than Pt/C (77.9%). The E_{1/2} and diffusion-limited current density of LFP/C-1 shows only slight declines of 6 mV and 0.3 mA cm⁻², respectively, after continuous 500 cycles. Moreover, unlike Pt/C, LFP/C-1 exhibits a great tolerance to methanol crossover (inset in FIG. 5C). The activity loss during the long-term test may result from the demetallation of Fe species. Changes in surface species of LFP/C-1 during catalysis was investigated by XPS (FIG. 26). The semi-quantitative XPS analysis indicates that the relative contents of surface Fe and P (2.10 and 1.28 at. %) decrease to 1.20 and 1.76 at. %, respectively, and the initial 1.76 at. % of Li is completely removed. These results suggest that some residual LFP particles are dissolved during the cycling aging due to the loss of stable chemical bonding with the carbon matrix after the etching process. However, such a low surface Fe content in the cycled sample is also strongly affected by the increased O content from the adsorbed O-intermediates and water molecules during catalysis. The accurate total Fe loss was determined by ICP-OES as 0.3 wt. % (FIG. 17), which is smaller than the semi-quantitative XPS results. This suggests that demetallation mainly occurs on the surface and most LFP particles embedded inside carbon spheres are retained as evidenced by the post-cycling TEM image (FIG. 27).

Origin of Intrinsic Activity: Experimental and Theoretical Evidence

Overall, LFP/C-1 demonstrates the best ORR activity compared with other pristine and etched analogues. Such varied performances can be attributed to the different intrinsic activities and the synergetic effects of various Fe species created by the partial etching, as well as the porous carbon matrix that allows an efficient mass transfer. In the case of LFP/C-3, the only active site is N-doped carbon possessing low ORR activity, which explains its poor ORR performance. More important question is whether the performance difference between LFP/C-1 and LFP/C-2 is simply due to the different amount of Fe species (ca. 3.71 and 2.63%). According to our findings in a previous work,¹⁸ metallic Fe nanoclusters exhibit a very poor intrinsic ORR activity but can alter the binding strengths of intermediates on the adjacent Fe—N₄ SA site, therefore optimizing the ORR energy barriers. In this work, the large contrast in the ORR performances between pristine LFP/C and LFP/C-1 indicates that the SA_{Fe} is the active center. However, the roles of the residual LFP particles and FeO nanoclusters in the vicinity of O-coordinated SA_{Fe} sites are still ambiguous.

To exclude the contribution from low-active species and comprehend the effects of the local environment of Fe SA on ORR performance, poisoning experiments were carried out by adding 10 mM SCN⁻ into an acidic electrolyte (0.5 M H₂SO₄, FIG. 4D). The SCN⁻ strongly binds the Fe—O sites in the samples in acid, blocking their ORR activity, but not in base. As expected, the addition of SCN⁻ causes no decline in the ORR activity of LFP/C-3 that contains no SA_{Fe} sites. On the contrary, the ORR performances of LFP/C-2 and LFP/C-1 are suppressed, which indicates the existence of SA_{Fe} sites in both samples. In particular, after the complete inhibition of SA_{Fe} sites, the E_{1/2} of LFP/C-1 is reduced by 40 mV to almost the same value of LFP/C-3 (0.445 V), which is mostly composed of carbon. Similarly, the E_{1/2} of LFP/C-2 also declines but with a smaller value of 15 mV by the SCN⁻ binding of SA_{Fe} to reach also the similar value of LFP/C-3. This phenomenon suggests that (1) SA_{Fe} contributes the most to ORR activities of LFP/C-1 and LFP/C-2, and (2) the direct contribution from non-SA species, namely, nanoscale LFP residues and FeO clusters, is extremely low. Yet, the difference in ORR activities of LFP/C-1 and LFP/C-2 arises from their distinctive neighboring non-SA species that modulate the property of SA_{Fe} site.

Further insight into the synergistic effect among the different Fe sites was obtained through first-principles calculations. Based on the microscopic and spectroscopic evidences, a graphene slab model containing unsaturated FeO₄, (FeO₆)₂ cluster, and LFP bulk unit cell was constructed to represent the structure of LFP/C-1 (FIG. 5A, right). To generate the modeling structure of LFP/C-2, FeO₄ site and (FeO₆)₂ cluster were loaded on the graphene surface (FIG. 5A, middle). The SA_{Fe} site counterpart was also designed to involve only FeO₄ (FIG. 5A, left). Both the (FeO₆)₂ cluster and bulk LFP display inferior activities due to the strong bindings of O* and high energy barriers. Therefore, FeO₄ is believed to be the main active center in each structure, which is consistent with the experimental results. The Bader charge analysis manifests that the multiple metal species function as a “charge modulator”; more electrons are pulled from FeO₄ to themselves, thereby altering the net charge of Fe in FeO₄, with the values of 1.49|e|, 1.50|e|, and 1.52|e| for FeO₄, FeO₄/(FeO₆)₂, and FeO₄/(FeO₆)₂/LFP, respectively. As a result, the projected density of the states of the Fe d orbitals in FeO₄ for the three models theoretically demonstrates that its d-band center energy (E_{d}) relative to the Fermi level (E_{F}) gradually decreases with the incorporation of the (FeO₆)₂ cluster and LFP (FIG. 5B). When oxygen-containing intermediates (e.g., 1π valence orbital in lone pair O 2pₓ electron) react on the 3d orbitals of Fe, the coupling splits the energy level into bonding and antibonding states. Such electron pulling behaviors can modulate the electronic configuration of FeO₄, which causes more electronic occupancy in the antibonding states, therefore weakening the corresponding adsorption, as illustrated in FIG. 5C.

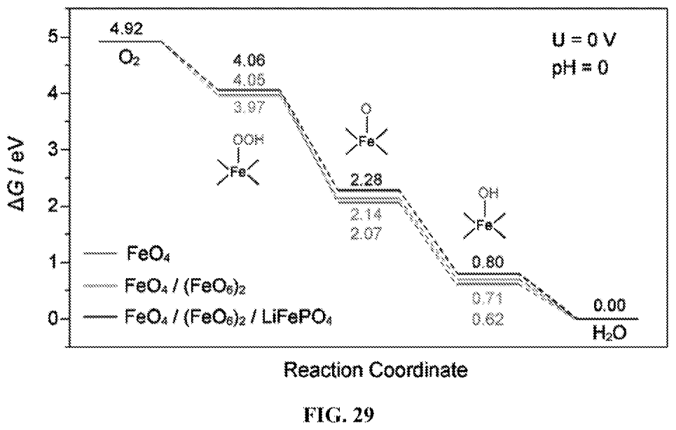

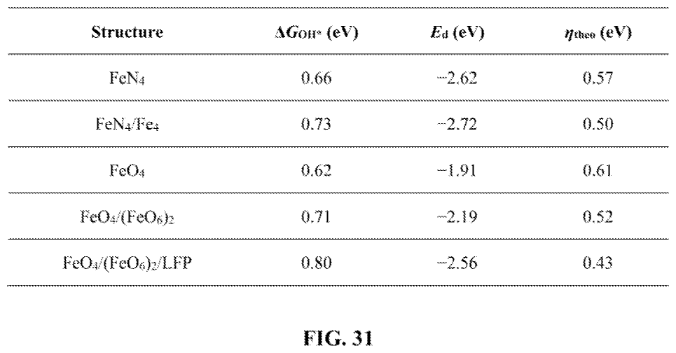

FIGS. 28 and 5D display the oxygen reduction pathways and energetic profiles on the FeO₄ site, which consists of four elementary electron/proton-coupled steps. In general, the rate-determining step for FeO₄, FeO₄/(FeO₆)₂, and FeO₄/(FeO₆)₂/LFP is the oxygen protonation of OH*, with the limiting energy barriers of 0.61, 0.52, and 0.43 eV, respectively. The introduction of clusters and particles is suggested to induce the weaker chemical binding with intermediates on the FeO₄ site, directly leading to the enhanced ORR activity. Considering similar systems that have been previously reported 22,23 and our previous work on FeN₄ SA and adjacent Fe₄ cluster,¹⁸ we correlate their E_{d} and theoretical overpotentials (ηₜₕₑₒ) with the Gibbs free energy of OH* (ΔG_{OH*}) as shown in FIG. 5E and FIG. 31. The constructed linear plots indicate that the presence of nearby (FeO₆)₂/LFP endows the FeO₄ site with the optimum d-state level, demonstrating the universality of this strategy to modulate the SA ORR activity by introducing proper cluster/particle-type neighbors. It is worth noting that the typical volcano relationship is not observed, which might imply further enhancement in ORR performance is possible. Overall, these calculation results manifest the preference of adjacent multi-atomic species for stimulating the intrinsic activity of FeO₄, although these multi-atomic species do not directly contribute much to the ORR catalytic process.

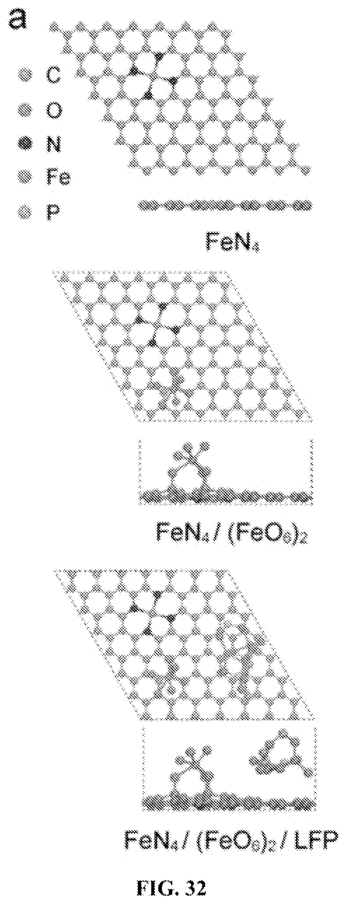

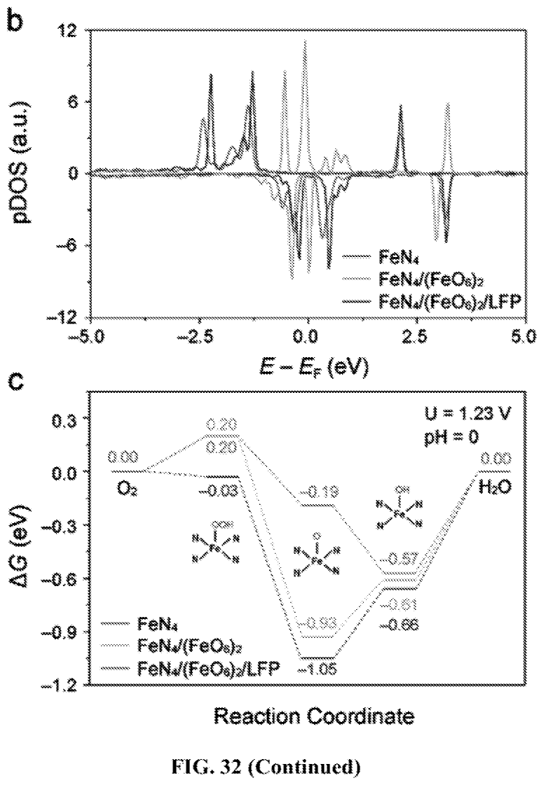

Unlike most reported single atomic sites coordinated with N atoms (e.g., Fe—N₄), the mild reaction conditions do not form Fe—N bonds in our LFP/C samples. It is interesting to know whether the (FeO₆)₂/LFP nearby the SA_{Fe} sites of different coordination would have the same effect on their ORR activities. To demonstrate the effect of SA-coordination atom, three similar models, but with the replacement of all Fe—O₄ sites by Fe—N₄, were established as shown in FIG. 32a. It turns out that the low d-band center of Fe—N₄ (E d=−2.62 eV) is greatly upshifted when accompanied by (FeO₆)₂ or (FeO₆)₂/LFP (FIG. 32b). This leads to the significant changes in energy barriers of each elementary step (FIG. 32c), and finally drags down the catalytic activity of Fe—N₄ itself, as manifested by the overpotential trend of FeN₄ (0.57 eV)<FeN₄/(FeO₆)₂ (0.61 eV)<FeN₄/(FeO₆)₂/LFP (0.66 eV). Overall, although the introduction of foreign cluster/particle to affect the intrinsic catalytic activity of SA is a general strategy, the selection of the right coordination is critical for higher performance. The reason for the shifted d-band of catalytic site needs to be further explored, and the model library to elucidate the interaction between sites needs to be further established.

Device Performances in Ammonia Fuel Cell and Rechargeable Zinc-Air Battery

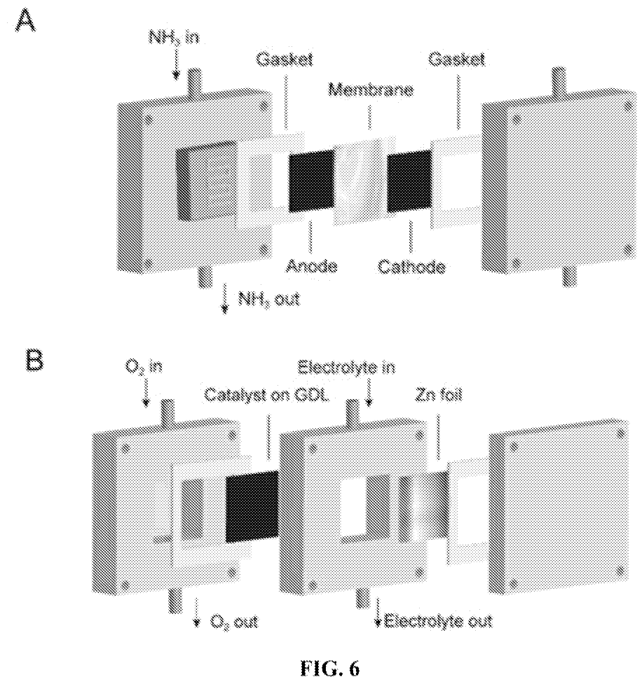

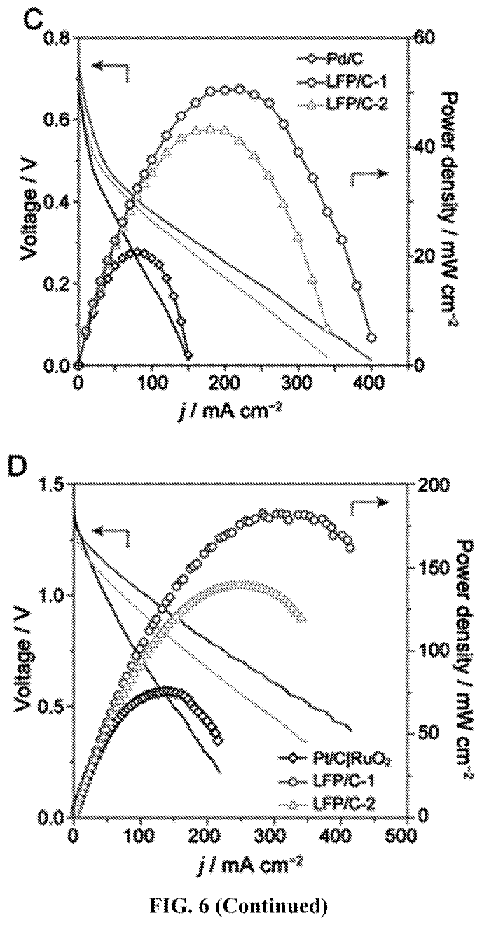

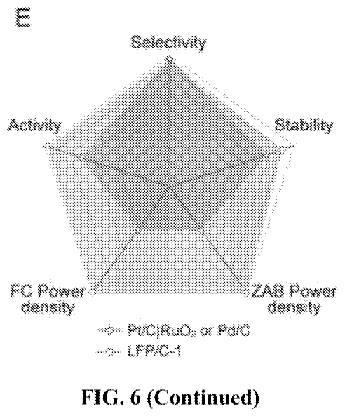

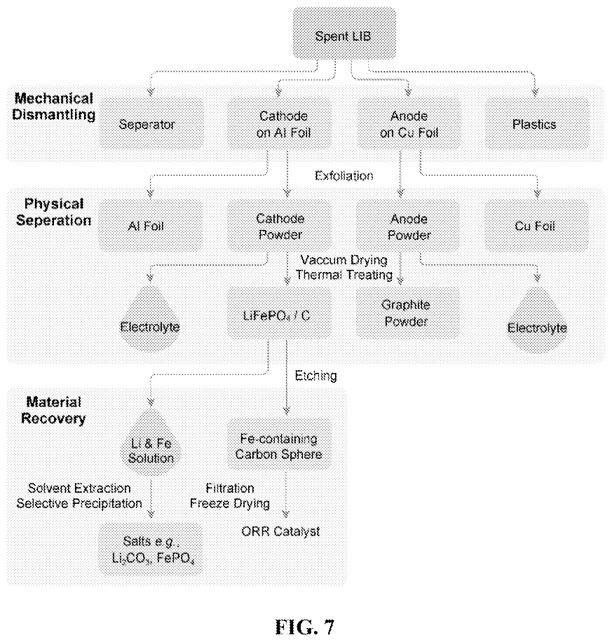

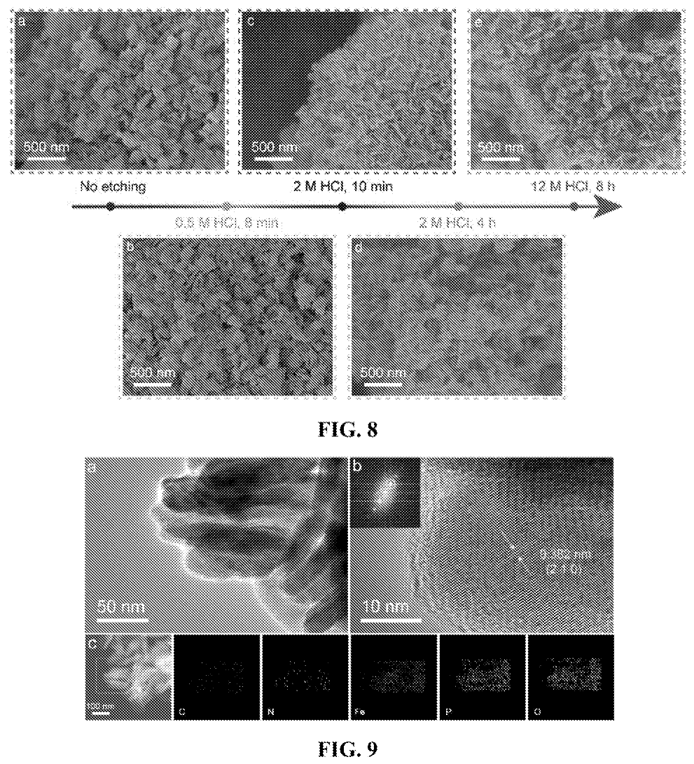

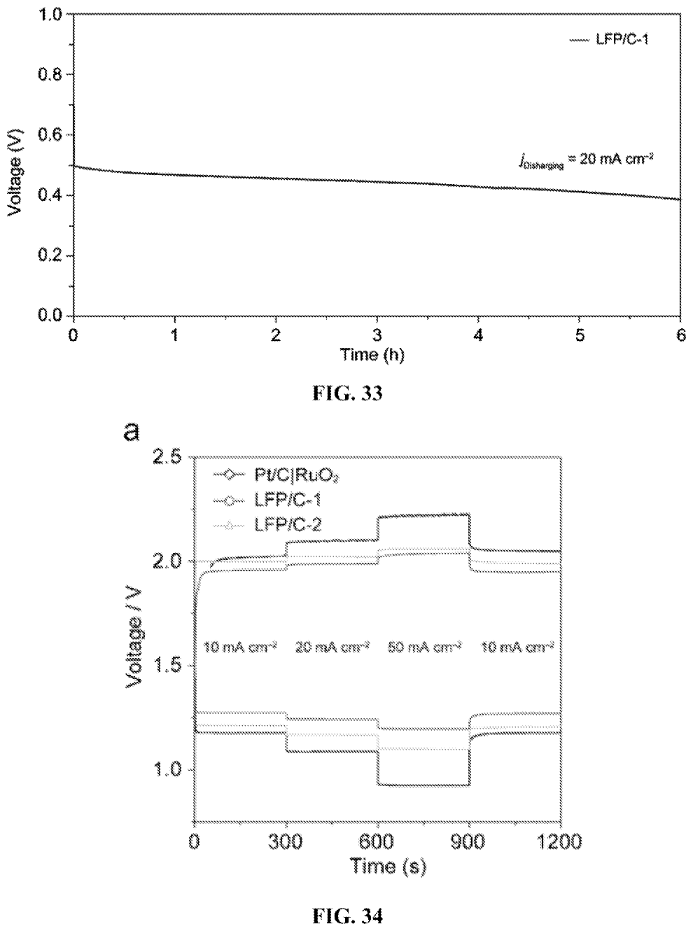

Based on the excellent ORR activity revealed by the half-cell catalytic reaction, the performances of ammonia fuel cell (FC) and rechargeable Zn—air battery (ZAB) engaging the etched LFP/C samples were evaluated. The details of the set-up and the preparation of membrane electrode assembly are illustrated in FIGS. 6A and 6B, as well as in Experimental Section. FIG. 6C shows the operation of a FC made of LFP/C samples as both anode and cathode using ammonia as the fuel at 80° C. With a loading amount of 1 mg cm⁻², the current densities of LFP/C-1, LFP/C-2, and commercial Pd/C are measured as ca. 240, 203, and 100 mA cm⁻² at 0.20 V, respectively, demonstrating the advantages of highly active SA Fe sites embedded in a porous hollow carbon structure of efficient mass/charge transport feature. In particular, LFP/C-1 delivers the highest maximum power density of 51 mW cm⁻² at 0.26 V, which largely exceeds that of Pd/C (21 mW cm⁻² at 0.20 V) and LFP/C-2 (43 mW cm⁻² at 0.24 V). In a constant current density test carried out with a high current density of 20 mA cm⁻² at 80° C. as the challenging condition for durability evaluation (FIG. 33), the cell voltage of the LFP/C-1-based FC shows a slow decay over a period of 6 h.

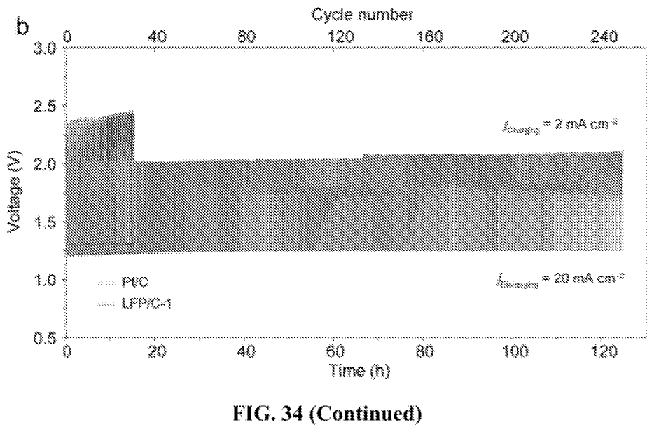

LFP/C-1, LFP/C-2, and the commercial Pt/C+RuO₂ catalyst were also employed as the air cathode in rechargeable ZABs (FIG. 6B). The ZAB fabricated with LFP/C-1 displays the highest discharging current density of ca. 410 mA cm⁻² under a high voltage (FIG. 6D). As a result, its peak power density (ca. 185 mW cm⁻²) surpasses that of LFP/C-2 (ca. 123 mW cm⁻²) and Pt/C+RuO₂ (ca. 76 mW cm⁻²). The charging/discharging rate performance was further evaluated at three current densities of 10, 20, and 50 mA cm⁻² (FIG. 34a). LFP/C-1 achieves a stable potential at all currents with good reversibility as demonstrated by well-retained working voltage after high-rate charge/discharge. FIG. 34b compares their long-term durability test results where the ZABs are cycled for 240 h (120 cycles) at high current densities (2 and 20 mA cm⁻² for charging and discharging processes, respectively). The cycling performance of LFP/C-1 is superior to Pt/C+RuO₂ as reflected by a stable charge/discharge voltage. After 250 continuous cycles, LFP/C-1 exhibits only a slight increase in the voltage gap (58 mV), compared with 108 mV in Pt/C+RuO₂. The Radar chart in FIG. 6E summarizes the half-cell reaction and the practical device performances from five dimensions (ORR activity, selectivity, stability, and the corresponding power densities of the FC and ZAB), which illustrates the superior behaviors of LFP/C-1 over commercial catalysts and proves and the potential of secondary utilization of waste LIB cathode.

To conclude, we report a case study of upcycling end-of-life LiFePO₄ cathode materials via a facile partial etching strategy. O-coordinated SA Fe sites were created inside the hollow N-doped carbon spheres with a few nanoscale FeO clusters and residual LFP nanoparticles. The resultant material exhibits excellent ORR activity/stability in an alkaline medium as manifested by the high Eₒₙₛₑₜ of 0.97 V and the slight current decline of 9.5% after a 16-h test. It also displays potential in practical ammonia FC and ZAB. The etching strategy breaks a long-standing stereotype by innovatively constructing atomic catalytic sites via a top-down approach. More importantly, this work demonstrates the potential value of spent LIB electrodes in the half-cell reaction of FC and ZAB, and builds a bridge between energy storage and conversion systems by a facile upcycling approach.

Methods

Physical Characterizations. The morphology of the samples was characterized by a field emission scanning electron microscope (FESEM, TESCAN MAIA3) and a transmission electron microscope (TEM, JEOL Model JEM-2100F, 200 kV) equipped with an energy dispersive X-ray spectrometer. High-angle annular dark-field scanning TEM (HAADF-STEM) images were taken using a JEM-ARM300F (300 kV) equipped with a CEOS spherical aberration corrector. Powder X-ray diffraction (PXRD) patterns were acquired by a SmartLab X-ray diffractometer (200 mA, 45 kV). X-ray photoelectron spectroscopy (XPS) was conducted on a Nexsa XPS system (Thermo Scientific Nexsa, Al kα, 12 kV) and the collected XPS spectra were analyzed using a CasaXPS software. Elemental composition analysis was performed by inductively coupled plasma optical emission spectrometry (ICP-OES) on an Agilent 710 Series spectrometer and elemental analyzer (EA) on a Shimadzu TOC-L CSN. Metal K-edge X-ray absorption spectroscopy (XAS) was carried out at beamline 17C of the National Synchrotron Radiation Research Center (NSRRC), Taiwan. For a measured spectrum, the extended X-ray absorption fine structure (EXAFS) function χ was obtained by subtracting the post-edge background from the initial spectrum and normalizing it to the edge jump step. The energy space of the normalized χ(E) was then transformed into the k space of χ(k). The χ(k) was multiplied by k² to compensate for the oscillation dampening in the high-k region, and the k²-weighted χ(k) data were converted to the R-space data by the Fourier transform (FT). Athena software was used to process the XAS data, including background subtraction, normalization of edge jump step, and FT of the k²-weighted χ(k) data. Artemis software was applied to fit the FT profiles.

Electrochemical Measurements. Electrocatalytic ORR activities of samples were measured with a potentiostat (PINE Wavedriver) using a three-electrode configuration in Ar- or O₂-saturated high-purity 1 M KOH at 25° C. A Hg/HgO electrode and a Pt foil served as the reference electrode and counter electrode, respectively. A rotating ring-disk electrode (RRDE) with a glassy carbon disk (0.248 cm²) and a Pt ring served as the bare working electrode. All the potentials were corrected against RHE without resistance compensation using the equation

E(vs.RHE)=E(vs.Hg/HgO)+0.098+0.059pH (1)

Catalyst ink was prepared by dispersing 5 mg of sample powder by ultrasonication in a mixed solution containing DI-water (0.5 mL), ethanol (0.5 mL), and 5 wt. % Nafion (20 μL). Control samples were prepared using commercial Pt/C (20 wt. %) to form 5 mg mL⁻¹ catalyst ink. 20 μL of catalyst ink was loaded on a RRDE for the test, making the final loading amount of catalyst to be 0.4 mg cm⁻². Cyclic voltammograms (CV) and linear sweep voltammograms (LSV) were recorded at scan rates of 50 and 5 mV s⁻¹, respectively. 10 cycles of CVs were swept to guarantee the catalyst was at a steady state before measuring each LSV curve. The background current for ORR was subtracted with the LSV measured in an Ar-saturated solution. Long-term stability was tested by measuring the current change of catalyst at a fixed potential (0.5 V vs. RHE) at 1,600 rpm.

Zn-air battery Test. A commercial two-electrode flow cell was used for Zn—air battery (ZAB) test. The air electrode consisted of a catalyst layer on the water-facing side and a gas diffusion layer on the air-facing side. The catalyst layer was made by loading catalyst and 5 wt. % Nafion™ onto the nickel foam (1×1 cm²) with a catalyst loading of 1 mg cm⁻². Then, the prepared catalyst layer was rolled onto a waterproof breathable film to form the air electrode. Pt/C+RuO₂ (1:1 mass ratio) mixed catalyst ink was prepared for comparison. ZAB was assembled with a zinc plate (1 cm×1 cm×0.5 mm) as the anode, the prepared air electrode as the cathode, and O₂-saturated 6 M KOH electrolyte containing 0.2 M Zn(CH₃COO)₂ as the electrolyte. A cycling pump was used for the continuous flowing of electrolyte and oxygen at room temperature. All electrochemical measurements for liquid ZAB were conducted on a PARSTAT MC potentiostat. The polarization curves were recorded by LSV at a scan rate of 5 mV s⁻¹. The galvanostatic charge-discharge curves were recorded by chronopotentiometry at a current density of 2 mA cm⁻² (charging) and 20 mA cm⁻² (discharging) with 30 min per cycle (15 min each for charge and discharge). Both the current density and peak power density were normalized to the effective surface area of the air electrode.

Ammonia Fuel Cell Test

The catalyst ink prepared by dispersing catalyst powder and 5 wt. % Nafion in ethanol was sprayed onto a carbon paper (Toray TGP-H-060) by an air gun to obtain a catalyst loading of 1 mg cm⁻² with an effective area of 1 cm². A commercial Pd/C catalyst electrode (Sigma-Aldrich, 0.5 mg cm⁻²) was used as the control cathode. A commercial Pt/C+RuO₂ (Johnson Matthey) electrode was used as the anode because it is known to be an excellent catalyst for NH₃ oxidation. The anion exchange membrane (Fumasep FAS-30) was soaked in 1 M KOH for 24 h, followed by washing with DI water. The anode, membrane, cathode, and gaskets were pressed to assemble into a fuel cell (FC). Ammonia with 3 M KOH and oxygen (99.999%) was fed to the cathode and anode through the serpentine flowing channels with a flow rate of 2 mL min⁻¹ and 10 sccm, respectively. The polarization curves and constant-current discharging curves of the FC were recorded using an electric load (Arbin BT2000, Arbin Instruments) at the operating temperature of 80° C.

Density Functional Theory Calculations

The spin-polarized plane wave density functional theory (DFT) was performed using the Vienna ab initio simulation package (VASP). The atomic structure of the systems was constructed based on experimental results. The ion-electron interaction was treated by the projector augmented wave (PAW) method. Electron exchange-correlation was represented by the functional of Perdew, Burke and Ernzerhof (PBE) of generalized gradient approximation (GGA). The cutoff of the energy for plane-wave basis was set to 500 eV. We applied periodic boundary conditions with a vacuum space of 15 Å to avoid interaction between the neighboring periodic structures. The convergence tolerance was 10⁻⁵ eV and 0.02 eV Å for energy and force, respectively. DFT-D3 calculations were used to describe the van der Waals (vdW) interaction. The k-points were generated automatically using the Monkhorste-Pack method, with a k-point mesh of 3×3×1 for the structure relaxation and electronic property calculations.

The ORR performance was characterized by the reaction free energy of the adsorbed intermediate (OOH, 0, OH) defined as:

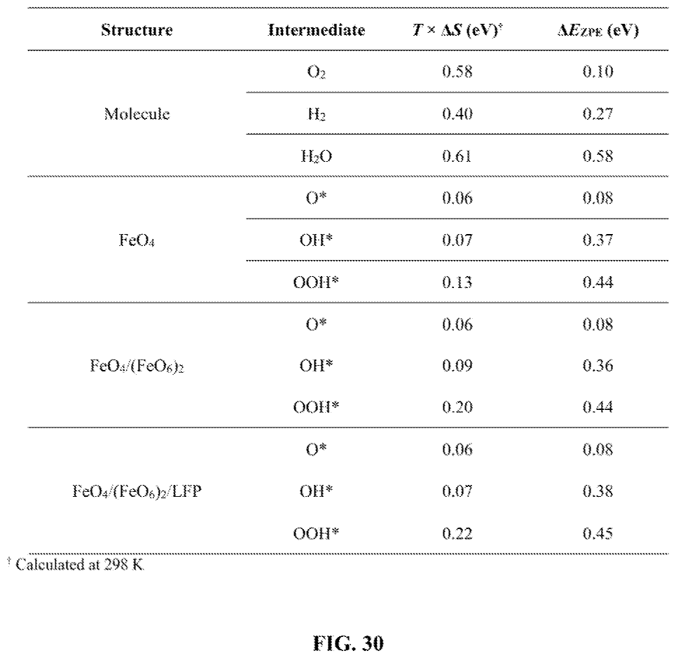

ΔG=ΔE+ΔZPE−T×ΔS (2)

where ΔG, ΔE, ΔZPE and T×ΔS are the change of the free energy, total energy from DFT calculations, zero-point energy and entropic contributions (T was set to be 298.15 K), respectively. The zero-point energy and T×ΔS can be obtained from vibrational frequencies derived from Hessians calculation from analytic gradients on single molecule in vacuum or adsorbates. The values used for corrections of ΔZPE and T×ΔS are calculated by frequencies and listed in FIG. 30. The Gibbs free energy of OH*, d-band center energy value, and theoretical overpotential are listed in FIG. 31.

What is claimed is:

1. A method of preparing an electrocatalyst, the method comprising: providing an electrode material obtained from a lithium-ion battery, wherein the electrode material comprises LiFePO₄@N-doped carbon core-shell particles; contacting the electrode material with an aqueous solution comprising an acid thereby forming the electrocatalyst; and optionally drying the electrocatalyst.

2. The method of claim 1, wherein the aqueous solution has a pH less than 3.

3. The method of claim 1, wherein the aqueous solution has a pH between −1 to 1.

4. The method of claim 1, wherein the acid selected from the group consisting of HCl, HBr, HI, H₂SO₄, MHSO₄, or a mixture thereof, wherein M is an alkali metal or an alkaline earth metal.

5. The method of claim 1, wherein the aqueous solution comprises HCl at a concentration of 1.5 to 2.5 M.

6. The method of claim 5, wherein the electrode material and the aqueous solution remain in contact for 5-240 minutes.

7. The method of claim 1, wherein the aqueous solution comprises HCl at a concentration of 1.75 to 2.25 M and the electrode material and the aqueous solution remain in contact for 5-15 minutes.

8. The method of claim 1, wherein the aqueous solution comprises HCl at a concentration of 1.8-2.2 M and the electrode material and the aqueous solution remain in contact for 10-240 minutes.

9. The method of claim 1, wherein the aqueous solution comprises HCl at a concentration of 1.8-2.2 M and the electrode material and the aqueous solution remain in contact for 5-15 minutes.

10. The method of claim 1, wherein the electrode material and the aqueous solution are contacted at a ratio of 0.1-1 mg of electrode material to 1 mL of aqueous solution.

11. The method of claim 1, wherein the electrocatalyst has a Brunauer-Emmett-Teller (BET) surface area between 500-800 m² g⁻¹.

12. The method of claim 1, wherein the electrocatalyst comprises iron at a concentration of 2.63-3.71 wt. %.

13. The method of claim 1 further comprising providing a crude electrode material comprising the LiFePO₄@N-doped carbon core-shell particles, a binder, and one or more volatile organic solvents, wherein the crude electrode material is obtained from the lithium-ion battery; extracting the crude electrode material with an organic solvent thereby removing at least a portion of the binder from the crude electrode material; and drying the crude electrode material thereby removing at least a portion of the one or more volatile organic solvents from the crude electrode material and forming the electrode material.

14. The method of claim 1, wherein the electrocatalyst is dried by freeze-drying.

15. The method of claim 1 further comprising combining the electrocatalyst with an electrolyte.

16. The method of claim of claim 15, wherein the electrolyte comprises a sulfonated tetrafluorethylene and perfluorovinylether copolymer.

17. The method of claim 1 further comprising affixing the electrocatalyst to a negative current collector.

18. The method of claim 1, wherein the aqueous solution comprises HCl at a concentration of 1.8-2.2 M and the electrode material and the aqueous solution remain in contact for 5-15 minutes; the electrode material and the aqueous solution are contacted at a ratio of 0.05-.15 mg of electrode material to 1 mL of aqueous solution; and the electrocatalyst has a Brunauer-Emmett-Teller (BET) surface area between 515.9-742.3 m² g⁻¹.

19. The method of claim 18, wherein the electrocatalyst comprises iron at a concentration of 2.63-3.71 wt. %.

20. The method of claim 19 further comprising depositing the electrocatalyst on a negative current collector.

21. An electrocatalyst prepared in accordance with the method of claim 1.

22. An electrochemical cell comprising:
an electrode comprising the electrocatalyst of claim 21;
a counter electrode;
optionally a reference electrode; and
an electrolyte.
